(19) United States
(12) Patent Application Publication
(10) Pub. No.: US 2022/0264879 A1
(43) Pub. Date: Aug. 25, 2022

(54) SYNERGISTIC HPPD MIXTURES

(71) Applicant: Adama Australia Pty Ltd, St. Leonards, New South Wales (AU)

(72) Inventors: Andrew HORSFIELD, St. Leonards, New South Wales (AU); Bevan ADDISON, Helena Valley (AU)

(21) Appl. No.: 17/636,651

(22) PCT Filed: Aug. 20, 2020
(86) PCT No.: PCT/AU2020/000084

§ 371 Date: Feb. 18, 2022

(30) Foreign Application Priority Data
Aug. 22, 2019 (AU) 2019903071

(51) Int. Cl. A01N 43/40; A01N 43/56; A01N 43/80; A01N 41/10; A01N 25/30

(52) U.S. Cl. CPC A01N 43/40; A01N 43/56; A01N 43/80; A01N 41/10; A01N 25/30

(57) ABSTRACT

Provided are combinations of one or more HPPD inhibitors selected from an isoxazole, a triketone, and a callistemone; a cereal crop safener selected from mefenpyr-diethyl, cloquintocet and cloquintocet-mexyl; and one or more of the herbicides, selected from the following groups:
i) a PSII inhibitor, including bromoxynil, ioxynil, and chlorotoluron
ii) a synthetic auxin, including halauxifen-methyl, fluroxypyr and MCPA
iii) a PPO inhibitor, including bifenox
iv) a PDS inhibitor, including flurochloridone, diflufenican and picolinafen.
   A method for controlling unwanted vegetation applying such a combination to a cereal crop is also described.

### TECHNICAL FIELD

The invention relates to novel synergistic mixtures containing HPPD inhibitors for use as herbicides.

### BACKGROUND ART

The efficiencies of herbicides depend largely on the type of one or more herbicides used, their application rates, the composition, the undesired harmful plants to be controlled in each case, climatic and soil conditions, etc. Additional criteria are inter alia persistency or the rate at which the herbicide is degraded. The changes in the susceptibility of harmful plants to an active compound which may occur on prolonged use or in a specific geographical region may also need to be taken into account. Such changes manifest themselves by an apparent loss in activity and can only be compensated to a limited extent by higher herbicide application rates.

For these large number of possible influencing factors, there is virtually no single individual active compound which may have all the desired properties for different requirements, in particular with respect to harmful plants species and the climatic zones. Moreover, there is always an object to achieve the desired effect using reduced herbicide application rates as much as possible. A lower application rate reduces not only the load of active compound required for the desired purpose, but generally also minimises the amount of formulation auxiliaries required. These factors help reduce the economic expenditures and also improve the environmental sustainability of the herbicide treatment.

4-Hydroxyphenylpyruvate dioxygenase (HPPD) inhibitors (HPPD inhibitors) are a such class of herbicides that inhibits hydroxyphenyl pyruvate dioxygenase (HPPD), an enzyme for converting hydroxymethyl pyruvate to homogentisate. This inhibition results in bleaching on new growth. The bleaching can continue through the plant, leading to necrosis or browning.

HPPD inhibitors are generally classified as Group F2 by HRAC (Herbicide Resistance Action Committee) and include, but not limited to:
Isoxazoles (e.g. Pyrasulfotole, Isoxaflutole);
Callistemones (e.g. Mesotrione);
Benzolpyrazole (e.g. Tolpyralate);
Pyrazoles (e.g. Benzofenap, Pyrazolynate, Pyrazoxyfen);
Triketones (e.g. Bicyclopyrone, Sulcotrione, Tembotrione, Topramezone); and
Benzobicyclon.

A range of HPPD herbicides have been applied post-emergently in cereals, primarily for control of broadleaf weeds. Such HPPDs are co-formulated with herbicide crop safeners, such as cloquintocet-mexyl or mefenpyr-diethyl. Safeners have been used extensively to protect cereal crops from damage caused by selective herbicides, without efficiency of compromising weed control. The use of safened HPPD products enables a different mode of action to be used in cereals crops, such as wheat and barley, for the management of a wide range of weeds, including hard-to-control species and weed biotypes that have developed resistance to other modes of action.

Such HPPDs are currently applied with other herbicides, such as bromoxynil or MCPA, as co-formulations and/or tank mixtures.

Examples of HPPD herbicides which have been applied in this way in Australia and other countries, or for which such application is proposed, include:
Pyrasulfotole+Mefenpyr-diethyl+LVE MCPA (Commercial name: Precept);
Pyrasulfotole+Mefenpyr-diethyl+Bromoxynil (Commercial name: Velocity);
Bicyclopyrone+Cloquintocet-mexyl+Bromoxynil (Commercial name: Talinor); and
Topramezone+Cloquintocet-mexyl (Commercial name: Frequency).

Examples of other HPPD herbicides which are not currently commercially available in Australia but which may be applied in this way include, but not limited to:
Mesotrione (Commercial name outside Australia: Mesoflex)+Cloquintocet-mexyl, Mefenpyr-diethyl or other suitable safener; and
Tembotrione (Commercial name outside Australia: Laudis)+Cloquintocet-mexyl, Mefenpyr-diethyl or other suitable safener.

Alternative active ingredients commonly used for the same target weeds in cereal crops include, but are not limited:
Group C (PSII inhibitors) herbicides, which are also known to have activity on similar target weeds when applied post-emergence, such as diuron, chlorotoluron, bentazone, metribuzin, linuron, isoproturon, ioxynil and others. PSII inhibitors work in general by inhibiting photosynthesis or affecting carotenoid biosynthesis;
Group F1 (PDS inhibitors) herbicides, such as flurochloridone, diflufenican and picolinafen, often in two- or three-way mixtures with bromoxynil and/or MCPA. PDS inhibitors work by inhibiting phytoene dehydrogenase, an enzyme of carotenoid biosynthesis;
Synthetic auxin herbicides, such as fluroxypyr, aminopyralid, clopyralid, picloram, dicamba, 2,4-D, MCPA and halauxifen-methyl. Synthetic auxins are generally plant growth regulators which interfere with cell formation; and
Inhibitors of protoporphyrinogen oxidase (PPO inhibitors—HRAC Group E), which interfere with chlorophyll and heme production and produce highly reactive molecules that destroy the cell membrane of target weeds. They are applied either post-emergent in cereals (examples are carfentrazone-ethyl, pyraflufen and bifenox), or pre-sowing (examples are flumioxazin, butafenacil and saflufenacil (also used pre-harvest in some crops including cereals).

It has now been discovered, surprisingly, that certain new combinations of an HPPD herbicide with herbicides from the four groups listed immediately above and/or or an additional HPPD herbicide exhibit synergy when used for foliar application to control weed species in cereal crops.

In the context of the present subject matter, the term ‘synergy’ is as defined by Colby S R in an article ‘Calculation of the synergistic and antagonistic responses of herbicidal combinations’ published in the journal Weeds 1967, 15, p 20-22, incorporated herein in its entirety.

### SUMMARY OF THE INVENTION

The invention provides a synergistic herbicidal combination for controlling a weed species in a cereal crop, wherein the combination includes:
an effective quantity of a suitable HPPD inhibitor;
an effective quantity of a safener suitable for the cereal crop; and
applied with one or more of the following herbicides:
   an effective quantity of a second HPPD inhibitor; and/or
   an effective quantity of a PSII inhibitor; and/or
   an effective quantity of a synthetic auxin; and/or
   an effective quantity of a PPO inhibitor; and/or
   an effective quantity of a PDS inhibitor.

Using the Colby formula in the article ‘Calculation of the synergistic and antagonistic responses of herbicidal combinations' published in the journal Weeds 1967, 15, p 20-22’, the results of field trials consistently demonstrated that chosen combinations are synergistic, with the Colby's ratios (Observed+Expected) greater than 1.01, and up to the range of approximately about 2.8.

The invention also provides a method of controlling a weed species in a cereal crop, the method includes, but not limited to, the step of applying to a cereal crop post-emergent, a synergistic herbicidal combination, wherein the combination includes, but not limited to:
an effective quantity of a suitable HPPD inhibitor;
an effective quantity of a safener suitable for the cereal crop; and
applied with one or more of the following herbicides:
   an effective quantity of a second HPPD inhibitor; and/or
   an effective quantity of a PSII inhibitor; and/or
   an effective quantity of a synthetic auxin; and/or
   an effective quantity of a PPO inhibitor; and/or
   an effective quantity of a PDS inhibitor.

It has been found that the use of the invention can provide improved control, with considerable synergy, for the following weed species, but not only limited to:
Fumitory (Fumaria spp)
Vetch (Vicia sativa)
Wild radish (Raphanus raphanistrum)
Bifora (Bifora testiculata)
Volunteer lupins (Lupinus spp)
Climbing buckwheat (Polygonum convolvulus).

Use of the invention may also provide control for one or more of the weed species listed above which include biotypes resistant to one or more herbicide modes of action.

The crop may be any suitable cereal crop, including, but not limited to, wheat, barley, cereal rye and triticale.

The suitable HPPD inhibitors are, but not limited to:
Pyrasulfotole: 5-Hydroxy-1,3-dimethylpyrazol-4-yl)(α,α,α-trifluoro-2-mesyl-p-tolyl)methanone);
Mesotrione: (2-[4-(Methylsulfonyl)-2-nitrobenzoyl]cyclohexane-1,3-dione;
Topramezone: [3-(4,5-dihydro-1,2-oxazol-3-yl)-4-(methanesulfonyl)-2-methyl-phenyl](5-hydroxy-1-methyl-1H-pyrazol-4-yl)methanon);
Sulcotrione: 2-(2-Chloro-4-(methylsulfonyl)benzoyl)cyclohexane-1,3-dione;
Tembotrione: 2-{2-Chloro-4-mesyl-3-[(2,2,2-trifluoroethoxy)methyl]benzoyl}cyclohexane-1,3-dione;
Bicyclopyrone: 4-hydroxy-3-{2-[(2-methoxyethoxyl)methyl]-6-(trifluoromethyl)-3-pyridyl]carbonyl}bicyclo[3.2.1]oct-3-en-2-one;

It is reasonably expected that other HPPD inhibitors in the same mixture combinations of the invention may also be synergistic, particularly on weeds that are within their activity spectrum. However, not all HPPD inhibitors will be synergistic and/or safe enough to apply to a cereal crop at rates effective on target weeds, even with the addition of known safeners such as mefenpyr-diethyl and cloquintocet-mexyl. For example, benzofenap applied with bromoxynil showed some synergy but overall was not effective on target weeds and did not require a safener to prevent phytotoxicity to wheat and barley.

In an embodiment, the HPPD inhibitor is an isoxazole, preferably Pyrasulfotole.

In another embodiment, the HPPD inhibitor is a triketone, preferably Bicyclopyrone or Topramezone.

In a further embodiment, the HPPD inhibitor is preferably Mesotrione.

The safener is preferably one or more from a group comprising mefenpyr-diethyl, cloquintocet and cloquintocet-mexyl.

When the herbicide is a PSII inhibitor, it is preferably one or more from a group comprising bromoxynil, ioxynil, and chlorotoluron.

When the herbicide is a PDS inhibitor, it is preferably one or more from a group comprising flurochloridone, diflufenican and picolinafen.

When the herbicide is a synthetic auxin, it is preferably one or more from a group comprising halauxifen-methyl, fluroxypyr and MCPA.

When the herbicide is a PPO inhibitor, it is preferably bifenox.

The synergistic herbicidal combination of the invention may include one or more herbicides from within a group, or herbicides from different groups. Examples are a PDS inhibitors such as (but not limited to) flurochloridone and/or diflufenican and/or picolinafen combined with bromoxynil and/or ioxynil, MCPA combined with fluroxypyr, MCPA combined with fluroxypyr combined with halauxifen-methyl, fluroxypyr combined with bromoxynil, chlorotoluron combined with bromoxynil and fluroxypyr combined with halauxifen-methyl.

As to effective quantities, the examples in the ongoing specification may provide only a guide. The following quantities and combinations may be specifically mentioned as preferences, using commercial names as identified in Table 1 below:
Arietta at 36 mL/ha plus AG-C6-060 EC at 200 mL/ha plus Triathlon at 500-1000 mL/ha;
Arietta at 36 mL/ha plus AG-C6-060 EC at 200 mL/ha plus LVE MCPA 570 at 220 mL/ha plus Elevore at 36-48 mL/ha;
Arietta at 36 mL/ha plus AG-C6-060 EC at 200 mL/ha plus LVE MCPA 570 at 220 mL/ha plus Flagship 400 at 250 mL/ha;
Arietta at 36 mL/ha plus AG-C6-060 EC at 200 mL/ha plus LVE MCPA 570 at 220 mL/ha plus Pixxaro at 150-200 mL/ha;
Frequency at 200 mL/ha plus Ioxynil 250 at 400 mL/ha;
Frequency at 200 mL/ha plus Ioxynil 250 at 400 mL/ha plus Bronco 400 at 250 mL/ha;
Frequency at 200 mL/ha plus Racer 250 at 100 mL/ha;
Frequency at 200 mL/ha plus Racer 250 at 100 mL/ha plus Bronco 400 at 250 mL/ha;
Frequency at 200 mL/ha plus Racer 250 at 100 mL/ha plus Ioxynil 250 at 400 mL/ha;
Mesoflex at 52 mL/ha plus AG-C6-060 EC at 210 mL/ha plus Flight at 360-720 mL/ha;
Mesoflex at 52 mL/ha plus AG-C6-060 EC at 210 mL/ha plus LVE MCPA 570 at 220 mL/ha plus Elevore at 36-48 mL/ha;
Mesoflex at 52 mL/ha plus AG-C6-060 EC at 210 mL/ha plus LVE MCPA 570 at 220 mL/ha plus Pixxaro at 150-200 mL/ha;
Mesoflex at 52 mL/ha plus AG-C6-060 EC at 210 mL/ha plus Quadrant at 600 mL/ha;
Mesoflex at 52 mL/ha plus AG-C6-060 EC at 210 mL/ha plus Triathlon at 500-1000 mL/ha;
Mesoflex at 52 mL/ha plus AG-C6-060 EC at 210 mL/ha plus Velocity at 400 mL/ha;
Precept at 1000 mL/ha plus Elevore at 36-48 mL/ha;
Precept at 1500 mL/ha plus Elevore at 48 mL/ha;
Precept at 1000 mL/ha plus Fox at 1000 mL/ha;
Precept at 1000-1500 mL/ha plus Pixxaro at 300 mL/ha;
Precept at 1000-1500 mL/ha plus Tolurex 90 WDG at 500 g/ha or Toluron at 1290 mL/ha;
Talinor at 400 mL/ha plus Elevore at 36-48 mL/ha;
Talinor at 400 mL/ha plus Flight at 360-720 mL/ha;
Talinor at 400 mL/ha plus Pixxaro at 200 mL/ha;
Talinor at 400 mL/ha plus Quadrant at 600 mL/ha;
Talinor at 400 mL/ha plus Triathlon at 500-1000 mL/ha;
Velocity at 400 mL/ha plus Elevore at 36-48 mL/ha;
Velocity at 400 mL/ha plus Flight at 720 mL/ha;
Velocity at 400 mL/ha plus Fox at 1000 mL/ha;
Velocity at 400 mL/ha plus Pixxaro at 200 mL/ha;
Velocity at 500 mL/ha plus Racer 250 at 100 mL/ha;
Velocity at 500 mL/ha plus Racer 250 at 100 mL/ha plus Ioxynil 250 at 400 mL/ha;
Velocity at 500-670 mL/ha plus Toluron 700 at 640-1290 mL/ha;
Velocity at 400 mL/ha plus Triathlon at 500-1000 mL/ha;
Velocity at 670 mL/ha plus Pixxaro at 300 mL/ha;

The invention is not limited to these combinations and quantities.

The combination may include any other desirable ingredient, including adjuvants. One preferred adjuvant is Hasten, a commercial name for a blend of esterified vegetable oil and non-ionic surfactants, suitable for use as a spray adjuvant with a range of agricultural chemicals including herbicides.

Another adjuvant that may be mentioned is Uptake, a commercial name for a mixture of a non-ionic surfactant and paraffinic oil.

Other adjuvants that may be mentioned also include non-ionic surfactants containing 1000 g/L alcohol alkoxylates such as (but not limited to) BS 1000.

In order that the invention in its various aspects may be more readily understood and put into practice, one or more preferred embodiments thereof will now be described.

### DETAILED DESCRIPTION OF PREFERRED EMBODIMENTS

Table 1 conveniently lists products referred to herein by their Product names:

TABLE 1
Product active ingredients and concentration

| Product | | Form. |
|---|---|---|
| name | Active ingredient(s) | Type |
| Adigor | Methyl Esters of Canola Oil Fatty Acid 440 g/L | EC |
| AG-C6-060 | Cloquintocet-mexyl 60 g/L | EC |
| EC | | |
| Arietta | Topramezone 336 g/L | SC |
| AD-AU-1826 | Florasulam 200 g/L | SC |
| Precept | Pyrasulfotole 25 g/L + LVE MCPA 125 g/L + | EC |
| | Mefenpyr-diethyl 6.25 g/L | |
| Bonanza Elite | Diflufenican 500 g/L | SC |
| Bronco 400 | Bromoxynil 400 g/L | EC |
| BS 1000 | Alcohol alkoxylates 1000 g/L | SL |
| Colt | Diflufenican 25 g/L + Bromoxynil 250 g/L | EC |
| Elevore | Halauxifen-methyl 68.5 g/L | SC |
| Flagship 400 | Fluroxypyr 400 g/L | EC |
| Flight | Bromoxynil 210 g/L + Picolinofen 35 g/L + | EC |
| | MCPA 350 g/L | |
| Fox | Bifenox 480 g/L | SC |
| Frequency | Topramezone 60 g/L + Cloquintocet- | SC |
| | mexyl 60 g/L | |
| Hasten 900 | Esterified vegetable oils 704 g/L + Non-ionic | EC |
| | surfactant 196 g/L | |
| Ioxynil 250 | Ioxynil 250 g/L | EC |
| LVE MCPA | MCPA present as the 2-ethylhexyl | EC |
| 570 | ester 570 g/L | |
| Mesoflex | Mesotrione 480 g/L | SC |
| Pixxaro | Fluroxypyr 250 g/L + Halauxifen-methyl | EC |
| | 16.25 g/L + Cloquintocet-mexyl 16.25 g/L | |
| Quadrant | Bromoxynil 240 g/L + Picolinafen 10 g/L + | EC |
| | Diflufenican 20 g/L + MCPA 250 g/L | |
| Racer 250 | Flurochloridone 250 g/L | EC |
| Talinor | Bicyclopyrone 37.5 g/L + Bromoxynil | EC |
| | 175 g/L + Cloquintocet-mexyl 9.4 g/L | |
| Tolurex 90 | Chlorotoluron 900 g/kg | WG |
| WDG | | |
| Toluron 700 | Chlorotoluron 700g/kg | WG |
| SC | | |
| Triathlon | Diflufenican 25 g/L + LVE MCPA 250 g/L + | EC |
| | Bromoxynil 150 g/L | |
| Uptake | Non-ionic surfactant 240 g/L + paraffinic | EC |
| | oil 582 g/L | |
| Velocity | Pyrasulfotole 37.5 g/L + Bromoxynil 210 g/L + | EC |
| | Mefenpyr-diethyl 9.4 g/L | |

Each of the above products can be obtained from Adama Australia, St Leonards, New South Wales, Australia, except for:

Adigor, available from Syngenta Australia, PO Box 886 North Ryde NSW 1670, Australia

Arietta, obtainable from BASF New Zealand Limited, P.O. Box 407, Auckland 1140, New Zealand;

BS 1000 and Flight, obtainable from Nufarm, 103-105 Pipe Road, Laverton North, Victoria 3026;

Elevore, obtainable from Corteva Agriscience, 9330 Zionsville Road, Indianapolis, Ind. 46268, United States of America;

Fox, obtainable from Adama Agricultural Solutions UK Limited, Unit 15, Thatcham Business Village Colthrop Way, Thatcham, Berkshire RG19 4LW, England;

Frequency, obtainable from BASF Australia Ltd, Level 12, 28 Freshwater Place, Southbank VICTORIA 3006

Ioxynil 250, obtainable from Eurochem, TGAC Australia Pty Ltd. 9 Heales Road, Lara, Victoria 3212.

Mesoflex, obtainable from Adama New Zealand Ltd, Level 1, 93 Bolt Road, Tahunanui, Nelson 7011.

Pixxaro and Uptake, obtainable from Corteva Agriscience, Chatswood, New South Wales, Australia;

Racer 250, obtainable from Adama Agan, Ashdod, Israel.

Talinor, available from Syngenta Australia, PO Box 886 North Ryde NSW 1670, Australia

Velocity and Precept, obtainable from Bayer Crop Science Australia, Pymble, New South Wales, Australia;

AG-C6-060 EC is an experimental formulation developed by Adama Agan, Ashdod, Israel;

AD-AU-1826 is an experimental formulation developed by Adama Australia; and

Hasten 900, obtainable from Victorian Chemicals, Coolaroo, Victoria, Australia.

Chlorotoluron is not currently available as Tolurex 90 WDG. However, a sample of the previously commercially available formulation Tolurex 90 WDG, a water dispersible granule containing 900 g/kg chlorotoluron, was supplied by Adama Agan.

Toluron 700 SC, marketed by Adama Polska Sp.z.o.o., was also included in evaluations and can be used instead of Tolurex 90 WDG.

### Example 1

In this non-limiting example, the efficacy of herbicidal combinations was evaluated on multiple-herbicide resistant wild radish (Raphanus Raphanistrum), when applied post emergent in wheat (Triticum aestivum). Crop safety was assessed for all treatments.

The treatment details are set out in Table 2.

TABLE 2
Treatments from Example 1

| Trt | Treatment | Form | Form | | Rate | Other | Other |
|---|---|---|---|---|---|---|---|
| No. | Name | Conc | Unit | Rate | Unit | Rate | Rate Unit |
| 1 | Untreated Control | | | | | | |
| 2 | Colt | 275 | g/L | 1000 | mL/ha | 275 | g ai/ha |
| 3 | Triathlon | 425 | g/L | 1000 | mL/ha | 425 | g ai/ha |
| 4 | Bonanza Elite | 500 | g/L | 50 | mL/ha | 25 | g ai/ha |
| 5 | Velocity | 256.9 | g/L | 400 | mL/ha | 103 | g ai/ha |
| | Hasten | 900 | g/L | 1 | l/100 l | 900 | g ai/ha |
| 6 | Velocity | 256.9 | g/L | 670 | mL/ha | 172 | g ai/ha |
| | Hasten | 900 | g/L | 1 | l/100 l | 900 | g ai/ha |
| 7 | Velocity | 256.9 | g/L | 670 | mL/ha | 172 | g ai/ha |
| | LVE MCPA 570 | 570 | g/L | 350 | mL/ha | 200 | g ai/ha |
| | Hasten | 900 | g/L | 1 | l/100 l | 900 | g ai/ha |
| 8 | Velocity | 256.9 | g/L | 200 | mL/ha | 51.4 | g ai/ha |
| | Triathlon | 425 | g/L | 500 | mL/ha | 213 | g ai/ha |
| | Hasten | 900 | g/L | 1 | l/100 l | 900 | g ai/ha |
| 9 | Velocity | 256.9 | g/L | 300 | mL/ha | 77 | g ai/ha |
| | Triathlon | 425 | g/L | 750 | mL/ha | 320 | g ai/ha |
| | Hasten | 900 | g/L | 1 | l/100 l | 900 | g ai/ha |
| 10 | Velocity | 256.9 | g/L | 400 | mL/ha | 103 | g ai/ha |
| | Triathlon | 425 | g/L | 1000 | mL/ha | 425 | g ai/ha |
| | Hasten | 900 | g/L | 1 | l/100 l | 900 | g ai/ha |
| 11 | Velocity | 256.9 | g/L | 670 | mL/ha | 172 | g ai/ha |
| | Bronco 400 | 400 | g/L | 225 | mL/ha | 90 | g ai/ha |
| | Hasten | 900 | g/L | 1 | l/100 l | 900 | g ai/ha |
| 12 | Velocity | 256.9 | g/L | 670 | mL/ha | 172 | g ai/ha |
| | Bonanza Elite | 500 | g/L | 50 | mL/ha | 25 | g ai/ha |
| | Bronco 400 | 400 | g/L | 225 | mL/ha | 90 | g ai/ha |
| | Hasten | 900 | g/L | 1 | l/100 l | 900 | g ai/ha |
| 13 | Toluron 700 SC | 700 | g/L | 640 | mL/ha | 450 | g ai/ha |
| 14 | Toluron 700 SC | 700 | g/L | 1290 | mL/ha | 900 | g ai/ha |
| 15 | Velocity | 256.9 | g/L | 670 | mL/ha | 172 | g ai/ha |
| | Toluron 700 SC | 700 | g/L | 640 | mL/ha | 450 | g ai/ha |
| | Hasten | 900 | g/L | 1 | l/100 l | 900 | g ai/ha |
| 16 | Velocity | 256.9 | g/L | 670 | mL/ha | 172 | g ai/ha |
| | Toluron 700 SC | 700 | g/L | 1290 | mL/ha | 900 | g ai/ha |
| | Hasten | 900 | g/L | 1 | l/100 l | 900 | g ai/ha |
| 17 | Precept | 156.25 | g/L | 1500 | mL/ha | 234 | g ai/ha |
| | Hasten | 900 | g/L | 1 | l/100 l | 900 | g ai/ha |
| 18 | Precept | 156.25 | g/L | 1500 | mL/ha | 234 | g ai/ha |
| | Bonanza Elite | 500 | g/L | 50 | mL/ha | 25 | g ai/ha |
| | Hasten | 900 | g/L | 1 | l/100 l | 900 | g ai/ha |
| 19 | Precept | 156.25 | g/L | 1500 | mL/ha | 234 | g ai/ha |
| | Toluron 700 SC | 700 | g/L | 640 | mL/ha | 450 | g ai/ha |
| | Hasten | 900 | g/L | 1 | l/100 l | 900 | g ai/ha |
| 20 | Precept | 156.25 | g/L | 1500 | mL/ha | 234 | g ai/ha |
| | Toluron 700 SC | 700 | g/L | 1290 | mL/ha | 900 | g ai/ha |
| | Hasten | 900 | g/L | 1 | l/100 l | 900 | g ai/ha |

Toluron 700 SC was applied at 640 and 1290 mL/ha, on its own and in combination at both rates, with Velocity at 670 mL/ha and Precept at 1500 mL/ha. Velocity and Triathlon were mixed at rates of 200+500, 300+750 and 400+1000 mL/ha.

Mixes were compared with registered standards Colt at 1000 mL/ha, Triathlon at 1000 mL/ha, Velocity at 670 mL/ha±LVE MCPA 570 at 350 mL/ha and Precept at 1500 mL/ha. All treatments were applied using a spray volume of 100 L/ha to an established wheat crop at the beginning of stem elongation (BBCH 31) and wild radish at BBCH 31, with most plants about 30 cm in diameter.

This trial was located in a commercial wheat paddock in the Mingenew/Morawa farming region of Western Australia. Crop phytotoxicity and weed control were assessed at 3, 7, 14, 28 and 41 days after application (DA-A) with weed density counted at 57 DA-A. Plot yield was measured at 112 DA-A.

The wild radish targeted in this trial is a known difficult-to-control population, suspected of developing resistance to multiple herbicide modes of action groups including acetolactate synthase inhibitors, photosystem II inhibitors, phytoene desaturase inhibitors and synthetic auxins.

All treatments were safe to apply to Calingiri wheat.

The percent control of wild radish is set out in Table 3.

TABLE 3
Wild radish (Raphanus raphanistrum) Percent Control

| | | | | Other | Treatment - Evaluation Interval for Example 1 | | | | | |
|---|---|---|---|---|---|---|---|---|---|---|
| Trt | Treatment | | Rate | Rate | 3 | 8 | 14 | 28 | 41 | 57 |
| No. | Name | Rate | Unit | g/ai/ha | DA-A | DA-A | DA-A | DA-A | DA-A | DA-A |
| 1 | Untreated | | | | 0.0 | 0.0 | 0.0 | 0.0 | 0.0 | 0.0 |
| | Control | | | | | | | | | |
| 2 | Colt | 1000 | ml/ha | 275 | 8.8 | 26.3 | 52.5 | 47.5 | 53.8 | 65.0 |
| 3 | Triathlon | 1000 | ml/ha | 425 | 12.5 | 31.3 | 58.8 | 65.0 | 62.5 | 68.8 |
| 4 | Bonanza | 50 | ml/ha | 25 | 2.5 | 16.3 | 33.8 | 15.0 | 11.3 | 16.3 |
| | Elite | | | | | | | | | |
| 5 | Velocity | 400 | ml/ha | 103 | 2.5 | 25.0 | 55.0 | 63.8 | 70.0 | 75.0 |
| | Hasten | 1 | l/100 l | 900 | | | | | | |
| 6 | Velocity | 670 | ml/ha | 172 | 5.0 | 27.5 | 52.5 | 56.3 | 66.8 | 76.3 |
| | Hasten | 1 | l/100 l | 900 | | | | | | |
| 7 | Velocity | 670 | ml/ha | 172 | 8.8 | 32.5 | 63.8 | 71.3 | 83.5 | 86.8 |
| | LVE MCPA | 350 | ml/ha | 200 | | | | | | |
| | 570 | | | | | | | | | |
| | Hasten | 1 | l/100 l | 900 | | | | | | |
| 8 | Velocity | 200 | ml/ha | 51.4 | 15.0 | 32.5 | 63.8 | 80.0 | 77.5 | 82.5 |
| | Triathlon | 500 | ml/ha | 213 | | | | | | |
| | Hasten | 1 | l/100 l | 900 | | | | | | |
| 9 | Velocity | 300 | ml/ha | 77 | 17.5 | 31.3 | 75.0 | 90.0 | 88.3 | 91.3 |
| | Triathlon | 750 | ml/ha | 320 | | | | | | |
| | Hasten | 1 | l/100 l | 900 | | | | | | |
| 10 | Velocity | 400 | ml/ha | 103 | 15.0 | 38.8 | 75.0 | 91.8 | 95.8 | 96.5 |
| | Triathlon | 1000 | ml/ha | 425 | | | | | | |
| | Hasten | 1 | l/100 l | 900 | | | | | | |
| 11 | Velocity | 670 | ml/ha | 172 | 6.3 | 30.0 | 73.8 | 75.0 | 82.5 | 86.3 |
| | Bronco 400 | 225 | ml/ha | 90 | | | | | | |
| | Hasten | 1 | l/100 l | 900 | | | | | | |
| 12 | Velocity | 670 | ml/ha | 172 | 6.3 | 30.0 | 76.3 | 86.3 | 86.8 | 87.8 |
| | Bonanza | 50 | ml/ha | 25 | | | | | | |
| | Elite | | | | | | | | | |
| | Bronco 400 | 225 | ml/ha | 90 | | | | | | |
| | Hasten | 1 | l/100 l | 900 | | | | | | |
| 13 | Toluron 700 | 640 | ml/ha | 450 | 1.3 | 0.0 | 7.5 | 2.5 | 2.5 | 5.0 |
| 14 | Toluron 700 | 1290 | ml/ha | 900 | 2.5 | 5.0 | 2.5 | 2.5 | 5.0 | 2.5 |
| 15 | Velocity | 670 | ml/ha | 172 | 7.5 | 26.3 | 58.8 | 56.3 | 75.0 | 76.3 |
| | Toluron 700 | 640 | ml/ha | 450 | | | | | | |
| | Hasten | 1 | l/100 l | 900 | | | | | | |
| 16 | Velocity | 670 | ml/ha | 172 | 8.8 | 26.3 | 58.8 | 75.0 | 82.0 | 85.8 |
| | Toluron 700 | 1290 | ml/ha | 900 | | | | | | |
| | Hasten | 1 | l/100 l | 900 | | | | | | |
| 17 | Precept | 1500 | ml/ha | 234 | 12.5 | 21.3 | 52.5 | 50.0 | 73.8 | 77.5 |
| | Hasten | 1 | l/100 l | 900 | | | | | | |
| 18 | Precept | 1500 | ml/ha | 234 | 11.3 | 23.8 | 47.5 | 72.5 | 78.8 | 84.5 |
| | Bonanza | 50 | ml/ha | 25 | | | | | | |
| | Elite | | | | | | | | | |
| | Hasten | 1 | l/100 l | 900 | | | | | | |
| 19 | Precept | 1500 | ml/ha | 234 | 15.0 | 20.0 | 46.3 | 53.8 | 78.8 | 81.3 |
| | Toluron 700 | 640 | ml/ha | 450 | | | | | | |
| | Hasten | 1 | l/100 l | 900 | | | | | | |
| 20 | Precept | 1500 | ml/ha | 234 | 17.5 | 13.8 | 45.0 | 55.0 | 73.8 | 80.0 |
| | Toluron 700 | 1290 | ml/ha | 900 | | | | | | |
| | Hasten | | l/100 l | 900 | | | | | | |

DA-A = Days after application

The Velocity+Triathlon tank mixes gave a clear rate response. At the highest rate tested it was the best performing treatment with final control of 97% and a count of 0.4 surviving plants per m². Velocity+LVE MCPA 570 was the best performing registered standard herbicide. Velocity+Triathlon at 400+1000 mL/ha respectively achieved more than 9% better efficacy than Velocity+LVE MCPA 570 with superior visual control coupled with significantly lower weed density. The combination of Velocity+Triathlon at 400+1000 mL/ha was also superior to other pyrasulfotole mixtures with Bronco 400 and Bronco 400 plus Bonanza, even when applied at higher rates of pyrasulfotole plus bromoxynil.

Velocity+Toluron 700 SC at 1290 mL/ha and Bonanza Elite mixed with Precept also controlled the multiple herbicide resistant wild radish, providing high levels of efficacy. The performance of these mixes was equivalent to the standard treatment, Velocity+LVE MCPA 570.

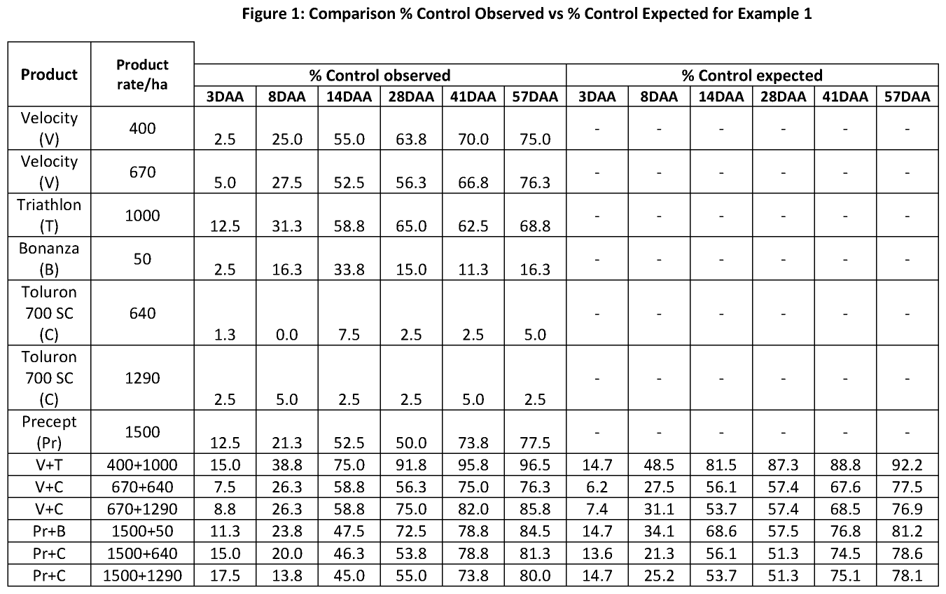

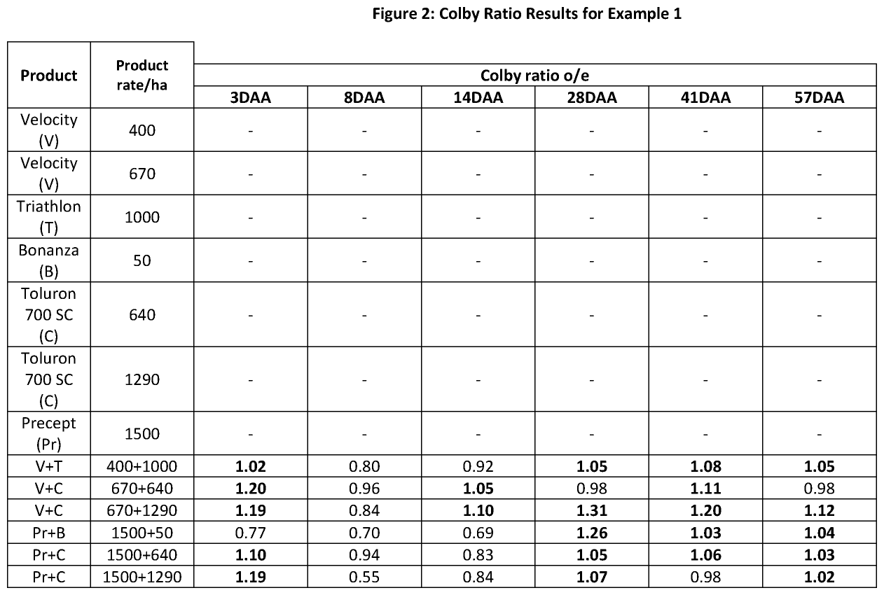

FIG. 1 shows percent control of wild radish expected and observed for Example 1, while FIG. 2 shows the Colby Ratios. All of the combinations according to the invention showed synergy in controlling wild radish.

### Example 2

In this non-limiting example, a small plot trial was established in a commercial field near Walkaway, Wash. to evaluate the efficacy of new mixtures on multiple-herbicide resistant wild radish (Raphanus Raphanistrum) when applied post emergent in wheat (Triticum aestivum). Crop safety was also assessed for all treatments.

The product names were as listed in Table 1 above. The treatment details were as listed in Table 2 above.

Toluron 700 SC was applied at 640 and 1290 mL/ha on its own and in combination with Velocity at 670 mL/ha and separately with Precept at 1500 mL/ha. Velocity and Triathlon were mixed at rates of 200+500, 300+750 and 400+1000 mL/ha. Bonanza Elite at 50 mL/ha was mixed with Precept at 1500 mL/ha. These mixes were compared with commercial standards Colt at 1000 mL/ha, Triathlon at 1000 mL/ha, Velocity at 670 mL/ha±LVE MCPA 570 at 350 mL/ha and Precept at 1500 mL/ha. All treatments were applied using a spray volume of 100 L/ha to an established wheat crop at the beginning of stem elongation (BBCH 31) and wild radish population (BBCH 30, 15-20 cm diameter).

Crop phytotoxicity and weed control were assessed at 3, 7, 14, 28 and 41 days after application (DA-A). Weed density was counted at 50 DA-A and plot yield measured at 112 DA-A.

The wild radish population at the site is known to be difficult to control. It is suspected that the population had developing resistance to multiple herbicide modes of action groups including acetolactate synthase inhibitors, photosystem II inhibitors, phytoene desaturase inhibitors and synthetic auxins.

All treatments were safe to apply to Mace wheat at BBCH 31 under the growing conditions experienced at this site.

The percent control of wild radish is set out in Table 4.

TABLE 4
Wild radish (Raphanus raphanistrum) Percent Control

| | | | | Other | Treatment - Evaluation Interval for Example 2 | | | | | |
|---|---|---|---|---|---|---|---|---|---|---|
| Trt | Treatment | | Rate | Rate | 3 | 8 | 14 | 28 | 41 | 50 |
| No. | Name | Rate | Unit | g/ai/ha | DA-A | DA-A | DA-A | DA-A | DA-A | DA-A |
| 1 | Untreated | | | | 0.0 | 0.0 | 0.0 | 0.0 | 0.0 | 0.0 |
| | Control | | | | | | | | | |
| 2 | Colt | 1000 | ml/ha | 275 | 16.3 | 35.0 | 65.0 | 61.3 | 57.7 | 57.5 |
| 3 | Triathlon | 1000 | ml/ha | 425 | 20.0 | 30.0 | 66.3 | 70.0 | 58.8 | 58.8 |
| 4 | Bonanza | 50 | ml/ha | 25 | 2.5 | 18.8 | 31.3 | 7.5 | 5.0 | 0.0 |
| | Elite | | | | | | | | | |
| 5 | Velocity | 400 | ml/ha | 103 | 2.5 | 22.5 | 61.3 | 56.3 | 55.0 | 57.5 |
| | Hasten | 1 | l/100 l | 900 | | | | | | |
| 6 | Velocity | 670 | ml/ha | 172 | 7.5 | 30.0 | 66.3 | 65.0 | 72.5 | 66.3 |
| | Hasten | 1 | l/100 l | 900 | | | | | | |
| 7 | Velocity | 670 | ml/ha | 172 | 18.8 | 30.0 | 71.3 | 81.3 | 80.0 | 72.5 |
| | LVE MCPA | 350 | ml/ha | 200 | | | | | | |
| | 570 | | | | | | | | | |
| | Hasten | 1 | l/100 l | 900 | | | | | | |
| 8 | Velocity | 200 | ml/ha | 51.4 | 16.3 | 25.0 | 73.8 | 80.0 | 75.0 | 72.5 |
| | Triathlon | 500 | ml/ha | 213 | | | | | | |
| | Hasten | 1 | l/100 l | 900 | | | | | | |
| 9 | Velocity | 300 | ml/ha | 77 | 17.5 | 27.5 | 75.0 | 86.3 | 82.5 | 80.0 |
| | Triathlon | 750 | ml/ha | 320 | | | | | | |
| | Hasten | 1 | l/100 l | 900 | | | | | | |
| 10 | Velocity | 400 | ml/ha | 103 | 17.5 | 27.5 | 77.5 | 94.5 | 92.5 | 88.5 |
| | Triathlon | 1000 | ml/ha | 425 | | | | | | |
| | Hasten | 1 | l/100 l | 900 | | | | | | |
| 11 | Velocity | 670 | ml/ha | 172 | 7.5 | 27.5 | 71.3 | 68.8 | 67.5 | 67.5 |
| | Bronco 400 | 225 | ml/ha | 90 | | | | | | |
| | Hasten | 1 | l/100 l | 900 | | | | | | |
| 12 | Velocity | 670 | ml/ha | 172 | 7.5 | 30.0 | 78.8 | 82.5 | 81.3 | 81.3 |
| | Bonanza | 50 | ml/ha | 25 | | | | | | |
| | Elite | | | | | | | | | |
| | Bronco 400 | 225 | ml/ha | 90 | | | | | | |
| | Hasten | 1 | l/100 l | 900 | | | | | | |
| 13 | Toluron 700 | 640 | ml/ha | 450 | 3.8 | 10.0 | 5.0 | 2.5 | 7.5 | 0.0 |
| 14 | Toluron 700 | 1290 | ml/ha | 900 | 7.5 | 10.0 | 10.0 | 11.3 | 20.0 | 0.0 |
| 15 | Velocity | 670 | ml/ha | 172 | 10.0 | 27.5 | 67.5 | 713 | 65.0 | 73.8 |
| | Toluron 700 | 640 | ml/ha | 450 | | | | | | |
| | Hasten | 1 | l/100 l | 900 | | | | | | |
| 16 | Velocity | 670 | ml/ha | 172 | 10.0 | 27.5 | 73.8 | 70.0 | 68.8 | 72.5 |
| | Toluron 700 | 1290 | ml/ha | 900 | | | | | | |
| | Hasten | 1 | l/100 l | 900 | | | | | | |
| 17 | Precept | 1500 | ml/ha | 234 | 10.0 | 13.8 | 55.0 | 65.0 | 68.8 | 70.0 |
| | Hasten | 1 | l/100 l | 900 | | | | | | |
| 18 | Precept | 1500 | ml/ha | 234 | 16.3 | 22.5 | 66.3 | 85.0 | 77.5 | 81.3 |
| | Bonanza | 50 | ml/ha | 25 | | | | | | |
| | Elite | | | | | | | | | |
| | Hasten | 1 | l/100 l | 900 | | | | | | |
| 19 | Precept | 1500 | ml/ha | 234 | 16.3 | 21.3 | 61.3 | 80.0 | 80.0 | 79.8 |
| | Toluron 700 | 640 | ml/ha | 450 | | | | | | |
| | Hasten | 1 | l/100 l | 900 | | | | | | |
| 20 | Precept | 1500 | ml/ha | 234 | 16.3 | 21.3 | 65.0 | 77.5 | 65.0 | 75.0 |
| | Toluron 700 | 1290 | ml/ha | 900 | | | | | | |
| | Hasten | | l/100 l | 900 | | | | | | |

DA-A = Days after application

Velocity+LVE MCPA 570 was the best performing registered standard herbicide. Colt and Triathlon were less effective and did not provide adequate control of the wild radish.

Velocity+Triathlon at 400+1000 mL/ha was significantly better than Velocity+LVE MCPA 570 and Precept, and was also superior to other pyrasulfotole mixtures with Bronco 400 and Bonanza, even at higher rates of pyrasulfotole.

Precept mixed with Toluron 700 SC at 640-1290 mL/ha was synergistic on multiple herbicide resistant wild radish. The performance of these mixes was equivalent to Velocity+LVE MCPA 570.

Toluron 700 SC applied solo gave poor control of wild radish.

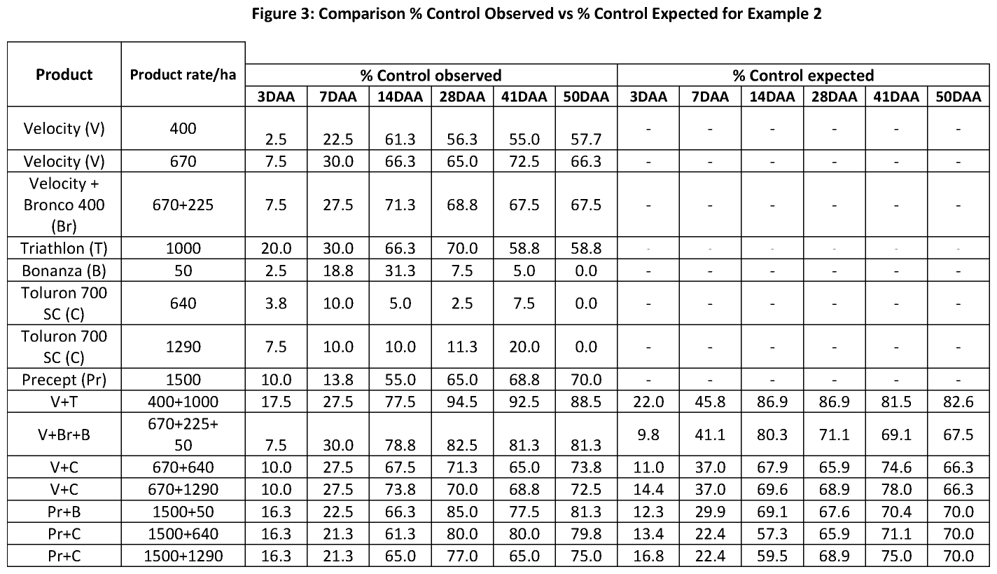

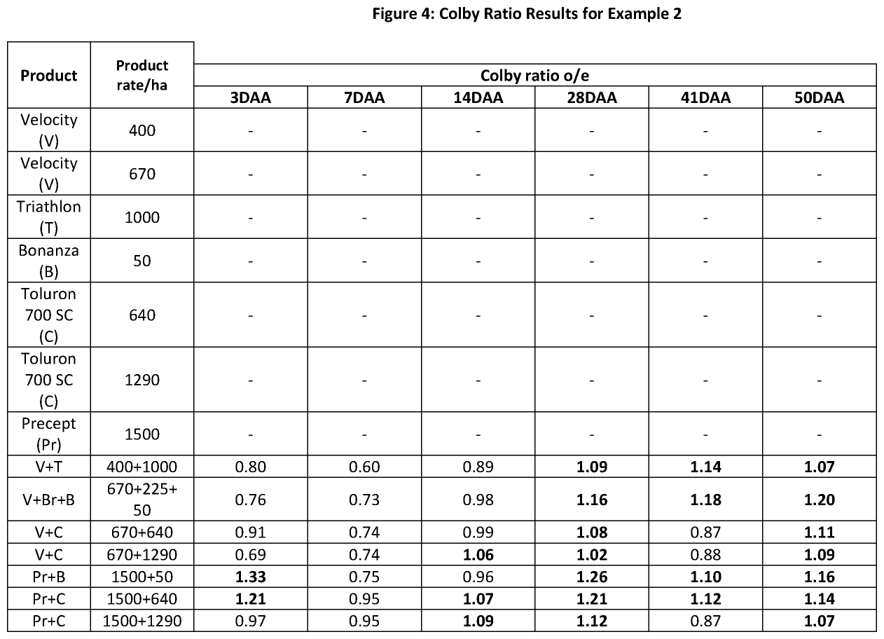

FIG. 3 attached shows percent control of wild radish expected and observed for Example 2, while FIG. 4 shows the Colby Ratios. All of the combinations according to the invention showed synergy in controlling wild radish.

### Example 3

The objective of the trial for this non-limiting example was to evaluate new herbicide mixtures for the control of bifora (Bifora testiculata), dense flowered fumitory (Fumaria and common vetch (Vicia sativa) in wheat cv. Scepter at Roseworthy, South Australia.

The product names were as listed in Table 1 above. The treatment details are listed in Table 5 below.

All herbicides were applied once the crop growth was at stage BBCH 31, when the majority of the bifora were at the 3-leaf stage. A total spray volume of 100 L/ha was applied using AirMix 110-015 nozzles.

A high population of bifora was present across the trial site at the time of application with 49 plants per square metre recorded in the untreated control. The wheat crop was at growth stage BBCH 31 when herbicide treatments were applied.

TABLE 5
Treatments for Example 3

| | | Rate | |
|---|---|---|---|
| | | Product | Active Ingredient |
| No. | Product | (mL or g/ha) | (g AI/ha) |
| 1 | Untreated control | Nil | Nil |
| 2 | Pixxaro + Uptake | 300 mL + 500 mL/100 L | 79.9 + 0.5% v/v |
| 3 | Triathlon | 1000 mL | 425 |
| 4 | Velocity + Uptake | 400 mL + 500 mL/100 L | 102.76 + 0.5% v/v |
| 5 | Velocity + Uptake | 670 mL + 500 mL/100 L | 172.1 + 0.5% v/v |
| 6 | Velocity + LVE | 670 mL + 350 mL + 500 mL/100 L | 172.1 + 200 + 0.5% v/v |
| | MCPA 570 + Uptake | | |
| 7 | Precept + Uptake | 1500 mL + 500 mL/100 L | 234.4 + 0.5% v/v |
| 8 | Velocity + | 670 mL + 300 mL + 500 mL/100 L | 172.1 + 79.9 + 0.5% v/v |
| | Pixxaro + Uptake | | |
| 9 | Velocity + | 400 mL + 1000 mL + 500 mL/100 L | 102.76 + 425 + 0.5% v/v |
| | Triathlon + Uptake | | |
| 10 | Precept + | 1500 mL + 300 mL + 500 mL/100 L | 234.4 + 79.9 + 0.5% v/v |
| | Pixxaro + Uptake | | |

All herbicide treatments were safe to wheat cv. Scepter under the conditions of this trial, with no grain yield penalties recorded.

Bifora Control

Percent control of bifora in wheat is shown in Table 6.

TABLE 6
Bifora (Bifora testiculata) control
in wheat cv. Scepter, Roseworthy

| | | | Bifora control | | | | |
|---|---|---|---|---|---|---|---|
| | | | (mean % relative to | | | | |
| | | | untreated control) | | | | |
| | | Rate | 3 | 7 | 13 | 35 | 45 |
| No. | Treatment | (g ai/ha) | DAA | DAA | DAA | DAA | DAA |
| 1 | Untreated | Nil | 0 | 0 | 0 | 0 | 0 |
| | control | | | | | | |
| 2 | Pixxaro\hat{ } | 79.9 | 42 | 68 | 83 | 68 | 75 |
| 3 | Triathlon | 425 | 25 | 33 | 50 | 20 | 38 |
| 4 | Velocity\hat{ } | 102.76 | 0 | 15 | 58 | 58 | 48 |
| 5 | Velocity\hat{ } | 172.1 | 0 | 22 | 72 | 58 | 63 |
| 6 | Precept\hat{ } | 234.4 | 32 | 28 | 55 | 38 | 33 |
| 7 | Tolurex 90 | 900 | 0 | 3 | 27 | 13 | 25 |
| 8 | Velocity + | 172.1 + | 22 | 33 | 72 | 63 | 48 |
| | LVE MCPA 570\hat{ } | 200 | | | | | |
| 9 | Velocity + | 172.1 + | 45 | 68 | 83 | 83 | 95 |
| | Pixxaro\hat{ } | 79.9 | | | | | |
| 10 | Velocity + | 102.76 + | 30 | 43 | 70 | 53 | 52 |
| | Triathlon\hat{ } | 425 | | | | | |
| 11 | Velocity + | 172.1 + | 0 | 18 | 67 | 43 | 53 |
| | Tolurex 90 | 900 | | | | | |
| 12 | Precept + | 234.4 + | 42 | 72 | 82 | 78 | 85 |
| | Pixxaro\hat{ } | 79.9 | | | | | |

\hat{ }= Treatment was applied with Uptake Spray Adjuvant at 500 mL/100 L
DAA = Days after application

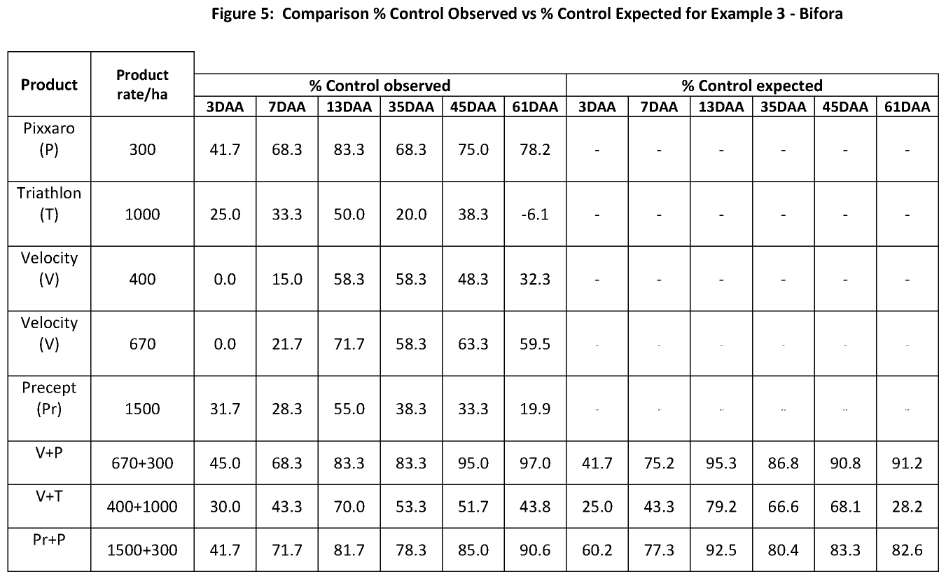

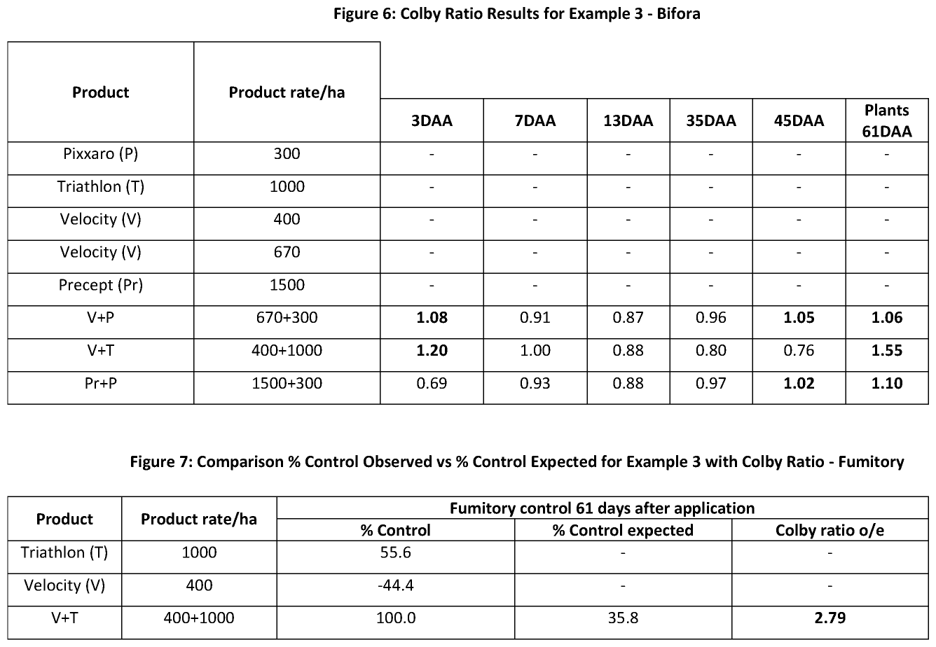

The efficacy of Pixxaro applied standalone declined over the 35DAA and 45DAA assessments. Both Pixxaro tank mix treatments with Velocity and Precept were synergistic and achieved superior control by 45DAA, with the Velocity combination recording a level of control that was significantly higher than all other treatments (FIGS. 5 and 6). Velocity at 400 mL/ha plus Triathlon at 1 L/ha provided rapid and synergistic early activity but declined over time.

Fumitory Control

Table 7 below shows percent control of fumitory in wheat.

TABLE 7
Dense-flowered fumitory (Fumaria densiflora)
control in wheat cv. Scepter, Roseworthy

| | | | Fumitory control | | | | |
|---|---|---|---|---|---|---|---|
| | | | (mean % relative to | | | | |
| | | | untreated control) | | | | |
| | | Rate | 3 | 7 | 13 | 35 | 45 |
| No. | Treatment | (g ai/ha) | DAA | DAA | DAA | DAA | DAA |
| 1 | Untreated | Nil | 0 | 0 | 0 | 0 | 0 |
| | control | | | | | | |
| 2 | Pixxaro\hat{ } | 79.9 | 55 | 72 | 87 | 100 | 100 |
| 3 | Triathlon | 425 | 40 | 48 | 57 | 92 | 83 |
| 4 | Velocity\hat{ } | 102.76 | 0 | 15 | 25 | 25 | 25 |
| 5 | Velocity\hat{ } | 172.1 | 0 | 20 | 28 | 28 | 47 |
| 6 | Precept\hat{ } | 234.4 | 47 | 47 | 67 | 100 | 20 |
| 7 | Tolurex 90 | 900 | 0 | 3 | 25 | 13 | 25 |
| 8 | Velocity + | 172.1 + | 42 | 47 | 68 | 100 | 100 |
| | LVE MCPA | 200 | | | | | |
| | 570\hat{ } | | | | | | |
| 9 | Velocity + | 172.1 + | 53 | 70 | 98 | 100 | 100 |
| | Pixxaro\hat{ } | 79.9 | | | | | |
| 10 | Velocity + | 102.76 + | 40 | 55 | 72 | 55* | 100 |
| | Triathlon\hat{ } | 425 | | | | | |
| 11 | Velocity + | 172.1 + | 2 | 18 | 30 | 8 | 25 |
| | Tolurex 90\hat{ } | 900 | | | | | |
| 12 | Precept + | 234.4 + | 52 | 72 | 88 | 100 | 92 |
| | Pixxaro\hat{ } | 79.9 | | | | | |

\hat{ }= Treatment was applied with Uptake Spray Adjuvant at 500 mL/100 L
DAA = Days after application

By 45DAA Velocity plus Triathlon was synergistic and recorded complete control of fumitory, which was significantly greater than the same rate of Velocity applied standalone, and was equivalent to Triathlon applied standalone (FIG. 7).

Common Vetch Control

Table 8 below shows percent control of common vetch in wheat.

TABLE 8
Common vetch (Vicia sativa) control
in wheat cv. Scepter, Roseworthy

| | | | Common vetch control | | | | |
|---|---|---|---|---|---|---|---|
| | | | (mean % relative to | | | | |
| | | | untreated control) | | | | |
| | | Rate | 3 | 7 | 13 | 35 | 45 |
| No. | Treatment | (g ai/ha) | DAA | DAA | DAA | DAA | DAA |
| 1 | Untreated | Nil | 0 | 0 | 0 | 0 | 0 |
| | control | | | | | | |
| 2 | Pixxaro\hat{ } | 79.9 | 33 | 62 | 80 | 83 | 90 |
| 3 | Triathlon | 425 | 20 | 38 | 43 | 53 | 70 |
| 4 | Velocity\hat{ } | 102.76 | 0 | 18 | 62 | 55 | 47 |
| 5 | Velocity\hat{ } | 172.1 | 0 | 23 | 70 | 63 | 67 |
| 6 | Precept\hat{ } | 234.4 | 27 | 38 | 50 | 65 | 55 |
| 7 | Tolurex 90 | 900 | 0 | 3 | 32 | 13 | 25 |
| 8 | Velocity + | 172.1 + | 18 | 42 | 65 | 65 | 58 |
| | LVE MCPA 570\hat{ } | 200 | | | | | |
| 9 | Velocity + | 172.1 + | 33 | 60 | 83 | 88 | 93 |
| | Pixxaro\hat{ } | 79.9 | | | | | |
| 10 | Velocity + | 102.76 + | 30 | 48 | 63 | 60 | 60 |
| | Pixxaro\hat{ } | 425 | | | | | |
| 11 | Velocity + | 172.1 + | 0 | 23 | 65 | 53 | 58 |
| | Tolurex 90\hat{ } | 900 | | | | | |
| 12 | Precept + | 234.4 + | 38 | 67 | 83 | 88 | 95 |
| | Pixxaro\hat{ } | 79.9 | | | | | |

\hat{ }= Treatment was applied with Uptake Spray Adjuvant at 500 mL/100 L
DAA = Days after application

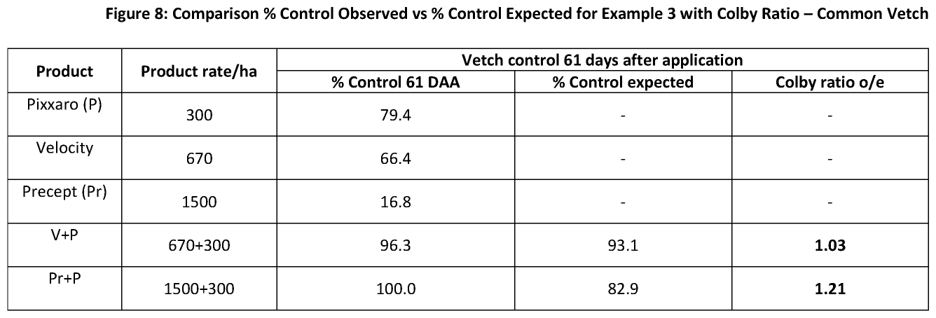

Velocity or Precept tank mixtures with Pixxaro were synergistic and provided the best control of common vetch (vetch). At 61DAA, Velocity+Pixxaro and Precept+Pixxaro were the most effective treatments on vetch, providing 96% and 100%, respectively (FIG. 8).

The tank mix of Velocity and Triathlon provided greater early efficacy on all weed species evaluated.

### Example 4

This trial evaluated new HPPD herbicide mixtures for the control of bifora (Bifora testiculata) in wheat cv. Scepter at Kybunga, South Australia. All herbicides were applied at crop growth stage BBCH 23 when the majority of the bifora were at the 4-leaf stage. A spray volume of 100 L/ha was applied. Standalone and tank mix treatments were compared to standard treatments of Velocity applied with and without LVE MCPA 570.

The product names were as listed in Table 1 above. The treatment details are listed in Table 9 below.

TABLE 9
Treatments for Example 4

| | | Rate | |
|---|---|---|---|
| | | Product | Active Ingredient |
| No. | Product | (mL or g/ha) | (g AI/ha) |
| 1 | Untreated control | Nil | Nil |
| 2 | Pixxaro + Uptake | 300 mL + 500 mL/100 L | 79.9 + 0.5% v/v |
| 3 | Triathlon | 1000 mL | 425 |
| 4 | Velocity + Uptake | 400 mL + 500 mL/100 L | 102.76 + 0.5% v/v |
| 5 | Velocity + Uptake | 670 mL + 500 mL/100 L | 172.1 + 0.5% v/v |
| 6 | Precept + Uptake | 1500 mL + 500 mL/100 L | 234.4 + 0.5% v/v |
| 7 | Tolurex 90 | 1000 g | 900 |
| 8 | Velocity + LVE MCPA | 670 mL + 350 mL + | 172.1 + 200 + |
| | 570 + Uptake | 500 mL/100 L | 0.5% v/v |
| 9 | Velocity + Pixxaro + | 670 mL + 300 mL + | 172.1 + 79.9 + |
| | Uptake | 500 mL/100 L | 0.5% v/v |
| 10 | Velocity + Triathlon + | 400 mL + 1000 mL + | 102.76 + 425 + |
| | Uptake | 500 mL/100 L | 0.5% v/v |
| 11 | Velocity + Tolurex 90 + | 670 mL + 1000 g + | 172.1 + 900 + |
| | Uptake | 500 mL/100 L | 0.5% v/v |
| 12 | Precept + Pixxaro + | 1500 mL + 300 mL + | 234.4 + 79.9 + |
| | Uptake | 500 mL/100 L | 0.5% v/v |

A moderate population of bifora was present across the trial site at the time of application with 17 plants per square metre recorded in the untreated control. Most of the herbicide treatments did not record any significant reduction in crop vigour relative to the untreated control.

Bifora Control

Table 10 contains the results for the percent control of bifora in wheat.

By the final assessment, Velocity standard treatments of 670 mL/ha solo or applied with LVE MCPA controlled bifora. Velocity tank mixed with either Pixxaro, Triathlon or Tolurex 90 provided greater early control of bifora than Velocity alone. When applied alone, Tolurex 90 recorded low bifora suppression. Precept standalone recorded only moderate suppression of bifora, but the tank mix with Pixxaro provided significantly greater control throughout the trial.

TABLE 10
Bifora (Bifora testiculata) control in wheat cv. Scepter, Kybunga

| | | Rate | Bifora control (mean % relative to untreated control) | | | | | |
|---|---|---|---|---|---|---|---|---|
| No. | Treatment | (g ai/ha) | 2 DAA | 8 DAA | 15 DAA | 21 DAA | 27 DAA | 44 DAA |
| 1 | Untreated | Nil | 0 | 0 | 0 | 0 | 0 | 0 |
| | control | | | | | | | |
| 2 | Pixxaro\hat{ } | 79.9 | 38 | 55 | 73 | 77 | 82 | 95 |
| 3 | Triathlon | 425 | 33 | 42 | 38 | 58 | 57 | 65 |
| 4 | Velocity\hat{ } | 102.76 | 0 | 23 | 63 | 65 | 70 | 90 |
| 5 | Velocity\hat{ } | 172.1 | 0 | 28 | 72 | 83 | 95 | 100 |
| 6 | Precept\hat{ } | 234.4 | 28 | 33 | 32 | 43 | 62 | 63 |
| 7 | Tolurex 90 | 900 | 0 | 0 | 12 | 20 | 8 | 20 |
| 8 | Velocity + | 172.1 + | 23 | 37 | 67 | 83 | 98 | 90 |
| | LVE MCPA 570\hat{ } | 200 | | | | | | |
| 9 | Velocity + | 172.1 + | 42 | 57 | 87 | 93 | 97 | 100 |
| | Pixxaro\hat{ } | 79.9 | | | | | | |
| 10 | Velocity + | 102.76 + | 30 | 52 | 87 | 95 | 95 | 98 |
| | Triathlon\hat{ } | 425 | | | | | | |
| 11 | Velocity + | 172.1 + | 0 | 28 | 88 | 93 | 100 | 100 |
| | Tolurex 90\hat{ } | 900 | | | | | | |
| 12 | Precept + | 234.4 + | 38 | 53 | 73 | 87 | 88 | 100 |
| | Pixxaro\hat{ } | 79.9 | | | | | | |

\hat{ }= Treatment was applied with Uptake Spray Adjuvant at 500 mL/100 L
DAA = Days after application

All herbicide treatments except Triathlon and Tolurex 90 recorded a significant reduction in bifora density compared to the untreated control. There were no further significant differences between any of these treatments for bifora density.

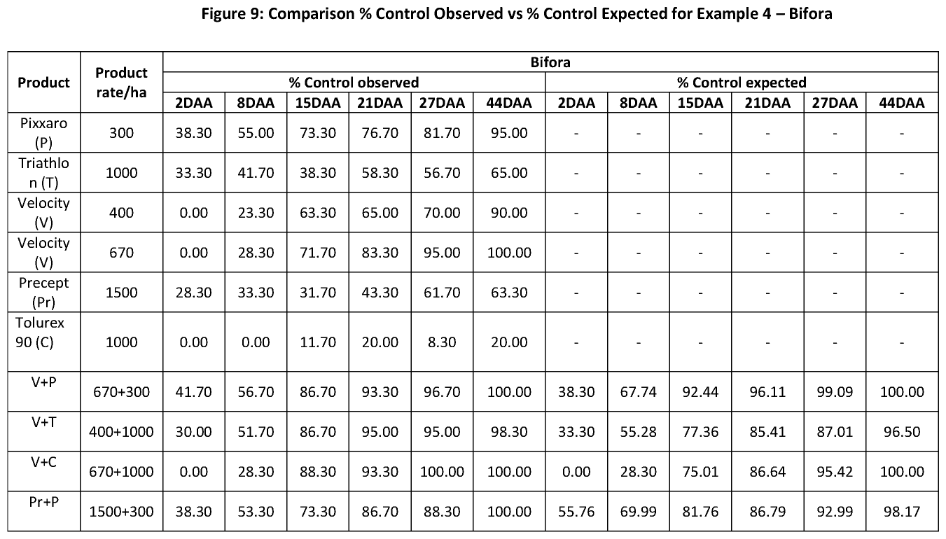

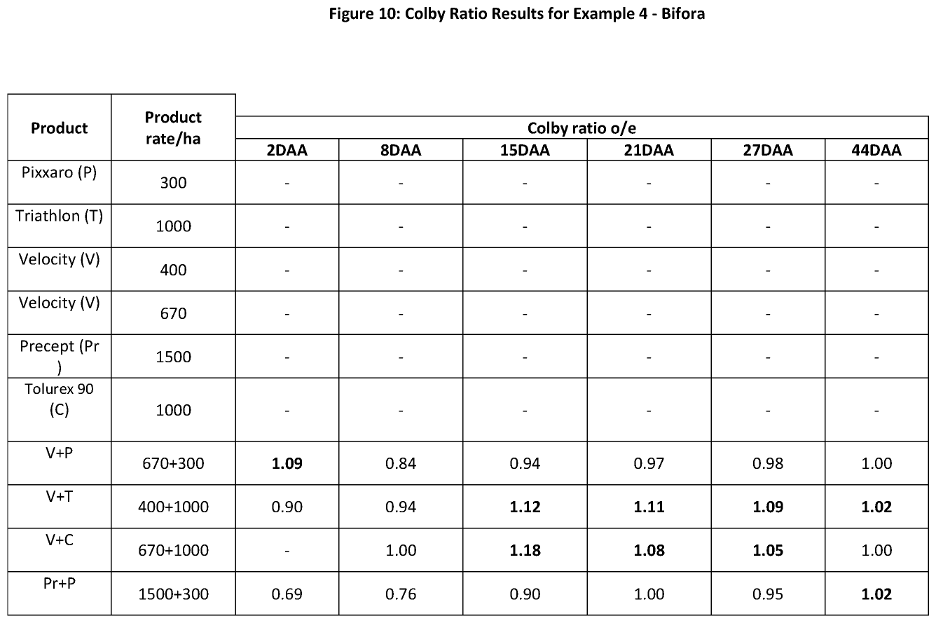

FIG. 9 attached shows percent control of bifora expected and observed for Example 4. FIG. 10 shows the Colby Ratios. All of the combinations according to the invention showed synergy in controlling bifora.

### Example 5

A field trial was conducted near Pirrinuan, Queensland to evaluate herbicide mixtures on climbing buckwheat (Polygonum convolvulus) in cereals.

The purpose of the trial was to evaluate the efficacy of mixtures including Velocity and Precept with Pixxaro, Triathlon, Tolurex 90 and Flagship 400 and to compare efficacy with standards including Pixxaro and Velocity for control of climbing buckwheat and crop safety in wheat cv. Suntop.

The product names were as listed in Table 1 above. The treatment details are listed in Table 11 below.

TABLE 11
Treatments for Example 5

| Trt | | | Rate | Rate |
|---|---|---|---|---|
| No. | Treatment | Active Ingredients | (gac/ha) | (mL/ha) |
| 1 | Untreated | — | — | — |
| 2 | Pixxaro\hat{ } | 250 g/L fluroxypyr + 16.25 g/L halauxifen | 79.9 | 300 |
| 3 | Pixxaro\hat{ } | 250 g/L fluroxypyr + 16.25 g/L halauxifen | 106.5 | 400 |
| 4 | Flagship | 400 g/L fluroxypyr | 100 | 250 |
| | 400\hat{ } | | | |
| 5 | Triathlon | 25 g/L diflufenican + 250 g/L MCPA + | 425 | 1000 |
| | | 150 g/L bromoxynil | | |
| 6 | Velocity\hat{ } | 210 g/L bromoxynil + 37.5 g/L pyrasulfotole | 99 | 400 |
| 7 | Velocity\hat{ } | 210 g/L bromoxynil + 37.5 g/L pyrasulfotole | 123.75 | 500 |
| 8 | Tolurex 90 | 900 g/kg chlorotoluron | 450 | 500 g |
| 9 | Tolurex 90 | 900 g/kg chlorotoluron | 900 | 1000 g |
| 10 | Velocity\hat{ } | 210 g/L bromoxynil + 37.5 g/L pyrasulfotole | 123.75 | 500 |
| | LVE MCPA | 570 g/L MCPA EHE | 200 | 350 |
| 11 | Velocity\hat{ } | 210 g/L bromoxynil + 37.5 g/L pyrasulfotole | 123.75 | 500 |
| | Pixxaro | 250 g/L fluroxypyr + 16.25 g/L halauxifen | 79.9 | 300 |
| 12 | Velocity\hat{ } | 210 g/L bromoxynil + 37.5 g/L pyrasulfotole | 123.75 | 500 |
| | Flagship | 400 g/L fluroxypyr | 100 | 250 |
| | 400 | | | |
| 13 | Velocity\hat{ } | 210 g/L bromoxynil + 37.5 g/L pyrasulfotole | 99 | 400 |
| | Triathlon | 25 g/L diflufenican + 250 g/L MCPA + | 425 | 1000 |
| | | 150 g/L bromoxynil | | |
| 14 | Velocity\hat{ } | 210 g/L bromoxynil + 37.5 g/L pyrasulfotole | 123.75 | 500 |
| | Tolurex 90 | 900 g/kg chlorotoluron | 900 | 1000 g |
| 15 | Precept\hat{ } | 125 g/L MCPA + 25 g/L pyrasulfotole | 150 | 1000 |
| 16 | Precept\hat{ } | 125 g/L MCPA + 25 g/L pyrasulfotole | 150 | 1000 |
| | Pixxaro | 250 g/L fluroxypyr + 16.25 g/L halauxifen | 79.9 | 300 |
| 17 | Precept\hat{ } | 125 g/L MCPA + 25 g/L pyrasulfotole | 150 | 1000 |
| | Flagship | 400 g/L fluroxypyr | 100 | 250 |
| | 400 | | | |
| 18 | Precept\hat{ } | 150 g/L fluroxypyr + 300 g/L bromoxynil | 150 | 1000 |
| | Tolurex 90 | 900 g/kg chlorotoluron | 450 | 500 g |
| 19 | Precept\hat{ } | 150 g/L fluroxypyr + 300 g/L bromoxynil | 150 | 1000 |
| | Tolurex 90 | 900 g/kg chlorotoluron | 900 | 1000 g |

\hat{ }0.5% v/v Uptake

Climbing Buckwheat Control

Table 12 below shows percent control of climbing buckwheat in wheat.

TABLE 12
Percent control of climbing buckwheat in wheat

| Trt | | Rate | 9 | 18 | 29 | 43 | 85 |
|---|---|---|---|---|---|---|---|
| No. | Treatment | (mL pr/ha) | DAA | DAA | DAA | DAA | DAA |
| 1 | Untreated | — | 0 | 0 | 0 | 0 | 0 |
| 2 | Pixxaro\hat{ } | 300 | 58 | 65 | 67 | 67 | 81 |
| 3 | Pixxaro\hat{ } | 400 | 57 | 63 | 68 | 68 | 91 |
| 4 | Flagship 400\hat{ } | 250 | 52 | 58 | 65 | 62 | 73 |
| 5 | Triathlon | 1000 | 50 | 62 | 72 | 78 | 59 |
| 6 | Velocity\hat{ } | 400 | 57 | 62 | 75 | 79 | 73 |
| 7 | Velocity\hat{ } | 500 | 57 | 72 | 78 | 87 | 86 |
| 8 | Tolurex 90 | 500 g | 3 | 7 | 10 | 23 | 0 |
| 9 | Tolurex 90 | 1000 g | 0 | 0 | 17 | 17 | 17 |
| 10 | Velocity\hat{ } | 500 | 62 | 70 | 72 | 75 | 68 |
| | LVE MCPA | 350 | | | | | |
| 11 | Velocity\hat{ } | 500 | 68 | 73 | 82 | 92 | 97 |
| | Pixxaro | 300 | | | | | |
| 12 | Velocity\hat{ } | 500 | 67 | 78 | 85 | 94 | 99 |
| | Flagship 400 | 250 | | | | | |
| 13 | Velocity\hat{ } | 400 | 68 | 83 | 87 | 96 | 94 |
| | Triathlon | 1000 | | | | | |
| 14 | Velocity\hat{ } | 500 | 67 | 75 | 78 | 78 | 74 |
| | Tolurex 90 | 1000 g | | | | | |
| 15 | Precept\hat{ } | 1000 | 52 | 67 | 72 | 82 | 76 |
| 16 | Precept\hat{ } | 1000 | 63 | 75 | 80 | 93 | 100 |
| | Pixxaro | 300 | | | | | |
| 17 | Precept\hat{ } | 1000 | 62 | 75 | 80 | 94 | 99 |
| | Flagship 400 | 250 | | | | | |
| 18 | Precept\hat{ } | 1000 | 57 | 68 | 77 | 77 | 88 |
| | Tolurex 90 | 500 g | | | | | |
| 19 | Precept\hat{ } | 1000 | 55 | 65 | 68 | 70 | 76 |
| | Tolurex 90 | 1000 g | | | | | |

\hat{ }0.5% v/v Uptake

Greater than 95% control of 4 to 28 leaf climbing buckwheat was provided by Velocity+Pixxaro, Velocity+Flagship 400, Precept+Pixxaro and Precept+Flagship 400 at 85 days after application (DAA). Inclusion of Flagship 400 with Velocity and inclusion of Flagship 400 or Pixxaro with Precept significantly enhanced control of climbing buckwheat.

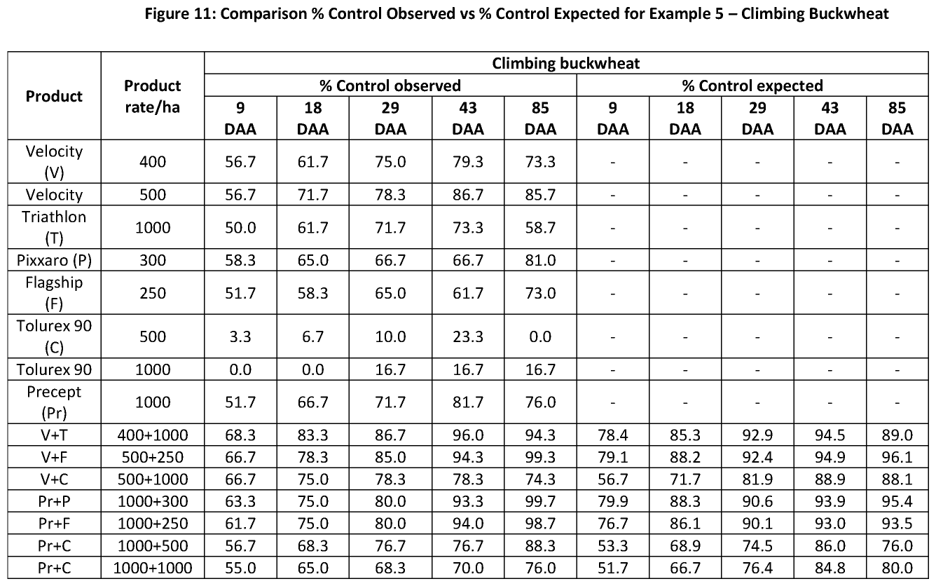

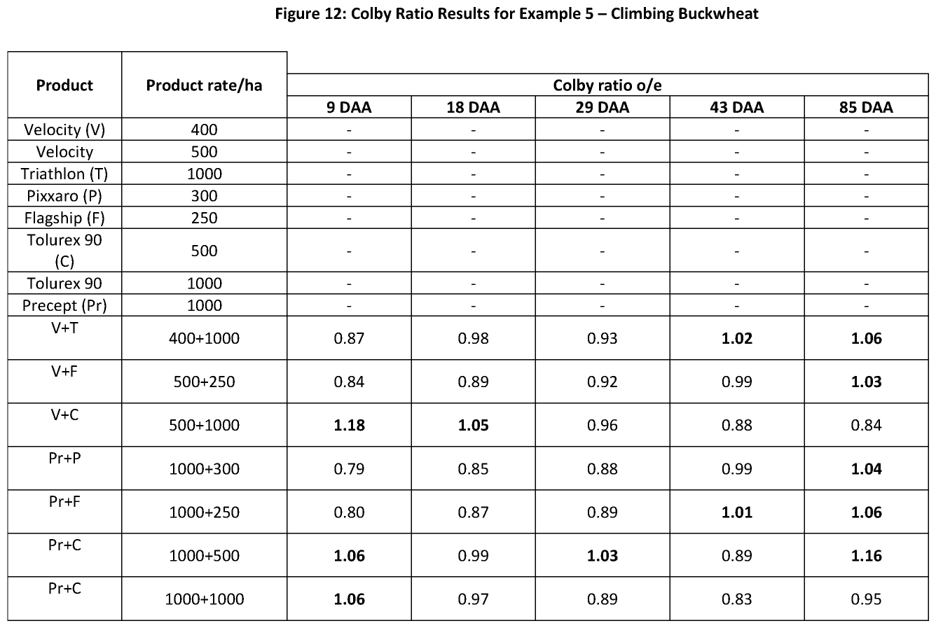

The results indicated that Velocity at 400 mL/ha plus Triathlon at 1 L/ha, Precept at 1 L/ha plus Pixxaro at 300 mL/ha, and Precept at 1 L/ha plus Tolurex 90 at 500 to 1000 g/ha were synergistic (FIGS. 11 and 12). There was also improved early activity of Velocity at 500 mL/ha when applied with Tolurex 90 at 1000 g/ha.

### Example 6

This trial was established at Walkaway in Western Australia in 2019 and targeted up to six leaf wild radish as a post-emergent application in wheat cv. Calingiri.

The objective of this trial was to evaluate a range of HPPD products mixed with Triathlon for control of wild radish. HPPD products included were Velocity, Talinor, Mesoflex and Arietta. Tank mixture partners included Triathlon and even a combination of Velocity plus Mesoflex.

The product names were as listed in Table 1 above. The treatment details are listed in Table 13 below.

TABLE 13
Treatments for Example 6

| Trt | Treatment | Product rate | | Rate | |
|---|---|---|---|---|---|
| No. | Name | (mL/ha) | | (g ac/ha) | |
| 1 | Untreated Control | | | | |
| 2 | Velocity | 670 | ml/ha | 172 | g ai/ha |
| | LVE MCPA 570 | 350 | ml/ha | 200 | g ai/ha |
| | Hasten | 1 l/100 l | | 900 | g ai/ha |
| 3 | Triathlon | 500 | ml/ha | 213 | g ai/ha |
| 4 | Triathlon | 1000 | ml/ha | 425 | g ai/ha |
| 5 | Velocity | 400 | ml/ha | 103 | g ai/ha |
| | Hasten | 1 l/100 l | | 900 | g ai/ha |
| 6 | Velocity | 400 | ml/ha | 103 | g ai/ha |
| | Triathlon | 500 | ml/ha | 213 | g ai/ha |
| | Hasten | 1 l/100 l | | 900 | g ai/ha |
| 7 | Velocity | 400 | ml/ha | 103 | g ai/ha |
| | Triathlon | 1000 | ml/ha | 425 | g ai/ha |
| | Hasten | 1 l/100 l | | 900 | g ai/ha |
| 8 | Talinor | 400 | ml/ha | 89 | g ai/ha |
| | Adigor | 0.5 l/100 l | | 220 | g ai/ha |
| 9 | Talinor | 400 | ml/ha | 89 | g ai/ha |
| | Triathlon | 500 | ml/ha | 213 | g ai/ha |
| | Adigor | 0.5 l/100 l | | 220 | g ai/ha |
| 10 | Talinor | 400 | ml/ha | 89 | g ai/ha |
| | Triathlon | 1000 | ml/ha | 425 | g ai/ha |
| | Adigor | 0.5 l/100 l | | 220 | g ai/ha |
| 11 | Mesoflex | 52 | ml/ha | 25 | g ai/ha |
| | AG-C6-060 | 210 | ml/ha | 12.6 | g ai/ha |
| | Hasten | 1 l/100 l | | 900 | g ai/ha |
| 12 | Mesoflex | 52 | ml/ha | 25 | g ai/ha |
| | AG-C6-060 | 210 | ml/ha | 12.6 | g ai/ha |
| | Triathlon | 500 | ml/ha | 213 | g ai/ha |
| | Hasten | 1 l/100 l | | 900 | g ai/ha |
| 13 | Mesoflex | 52 | ml/ha | 25 | g ai/ha |
| | AG-C6-060 | 210 | ml/ha | 12.6 | g ai/ha |
| | Triathlon | 1000 | ml/ha | 425 | g ai/ha |
| | Hasten | 1 l/100 l | | 900 | g ai/ha |
| 14 | Velocity | 400 | ml/ha | 103 | g ai/ha |
| | Mesoflex | 52 | ml/ha | 25 | g ai/ha |
| | AG-C6-060 | 210 | ml/ha | 12.6 | g ai/ha |
| | Hasten | 1 l/100 l | | 900 | g ai/ha |
| 15 | Arietta | 36 | ml/ha | 12.1 | g ai/ha |
| | AG-C6-060 EC | 200 | ml/ha | 12 | g ai/ha |
| | Hasten | 1 l/100 l | | 900 | g ai/ha |
| 16 | Arietta | 36 | ml/ha | 12.1 | g ai/ha |
| | AG-C6-060 EC | 200 | ml/ha | 12 | g ai/ha |
| | Triathlon | 500 | ml/ha | 213 | g ai/ha |
| | Hasten | 1 l/100 l | | 900 | g ai/ha |
| 17 | Arietta | 36 | ml/ha | 12.1 | g ai/ha |
| | AG-C6-060 EC | 200 | ml/ha | 12 | g ai/ha |
| | Triathlon | 1000 | ml/ha | 425 | g ai/ha |

| | | | |
|---|---|---|---|
| Hasten | 1 l/100 l | 900 | g ai/ha |

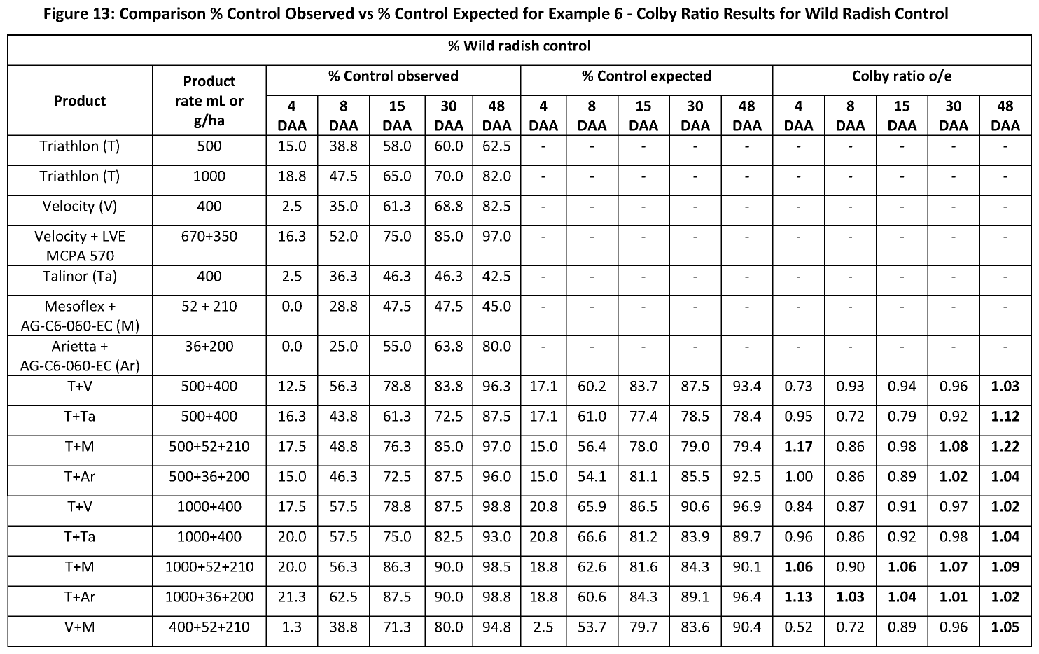

All tank mixtures evaluated were synergistic by the final assessment (FIG. 13). Triathlon at 500 and 1000 mL/ha was synergistic with all four HPPD inhibitor products. Additionally, the combination of Velocity at 400 mL/ha plus Mesoflex at 52 mL/ha+AG-C6-060 EC at 210 mL/ha was also synergistic.

### Example 7

This trial was established at West Casuarina in Western Australia in 2019 and targeted up to eight leaf wild radish with post-emergent applications of herbicides in a spray volume of 100 L/ha.

The objective of this trial was to evaluate a range of HPPD products mixed with Quadrant or Flight for control of wild radish. The product names were as listed in Table 1 above. HPPD products included were Velocity, Talinor and Mesoflex as per Table 14 below.

TABLE 14
Treatments for Example 7

| Trt | Treatment | Product rate | | Rate | |
|---|---|---|---|---|---|
| No. | Name | (mL/ha) | | (g ac/ha) | |
| 1 | Untreated Control | | | | |
| 2 | Velocity | 670 | ml/ha | 172 | g ai/ha |
| | LVE MCPA 570 | 350 | ml/ha | 200 | g ai/ha |
| | Hasten | 1 l/100 l | | 900 | g ai/ha |
| 3 | Flight | 360 | ml/ha | 214 | g ai/ha |
| 4 | Flight | 720 | ml/ha | 430 | g ai/ha |
| 5 | Quadrant | 600 | ml/ha | 312 | g ai/ha |
| 6 | Velocity | 400 | ml/ha | 103 | g ai/ha |
| | Hasten | 1 l/100 l | | 900 | g ai/ha |
| 7 | Velocity | 400 | ml/ha | 103 | g ai/ha |
| | Flight | 360 | ml/ha | 214 | g ai/ha |
| | Hasten | 1 l/100 l | | 900 | g ai/ha |
| 8 | Velocity | 400 | ml/ha | 103 | g ai/ha |
| | Flight | 720 | ml/ha | 430 | g ai/ha |
| | Hasten | 1 l/100 l | | 900 | g ai/ha |
| 9 | Talinor | 400 | ml/ha | 89 | g ai/ha |
| | Adigor | 0.5 l/100 l | | 220 | g ai/ha |
| 10 | Talinor | 400 | ml/ha | 89 | g ai/ha |
| | Flight | 360 | ml/ha | 214 | g ai/ha |
| | Adigor | 0.5 l/100 l | | 220 | g ai/ha |
| 11 | Talinor | 400 | ml/ha | 89 | g ai/ha |
| | Flight | 720 | ml/ha | 430 | g ai/ha |
| | Adigor | 0.5 l/100 l | | 220 | g ai/ha |
| 12 | Mesoflex | 52 | ml/ha | 25 | g ai/ha |
| | AG-C6-060 | 210 | ml/ha | 12.6 | g ai/ha |
| | Hasten | 1 l/100 l | | 900 | g ai/ha |
| 13 | Mesoflex | 52 | ml/ha | 25 | g ai/ha |
| | AG-C6-060 | 210 | ml/ha | 12.6 | g ai/ha |
| | Flight | 360 | ml/ha | 214 | g ai/ha |
| | Hasten | 1 l/100 l | | 900 | g ai/ha |
| 14 | Mesoflex | 52 | ml/ha | 25 | g ai/ha |
| | AG-C6-060 | 210 | ml/ha | 12.6 | g ai/ha |
| | Flight | 720 | ml/ha | 430 | g ai/ha |
| | Hasten | 1 l/100 l | | 900 | g ai/ha |
| 15 | Velocity | 400 | ml/ha | 103 | g ai/ha |
| | Quadrant | 600 | ml/ha | 312 | g ai/ha |
| | Hasten | 1 l/100 l | | 900 | g ai/ha |
| 16 | Talinor | 400 | ml/ha | 89 | g ai/ha |
| | Quadrant | 600 | ml/ha | 312 | g ai/ha |
| | Adigor | 0.5 l/100 l | | 220 | g ai/ha |
| 17 | Mesoflex | 52 | ml/ha | 25 | g ai/ha |
| | AG-C6-060 | 210 | ml/ha | 12.6 | g ai/ha |
| | Quadrant | 600 | ml/ha | 312 | g ai/ha |

| | | | |
|---|---|---|---|
| Hasten | 1 l/100 l | 900 | g ai/ha |

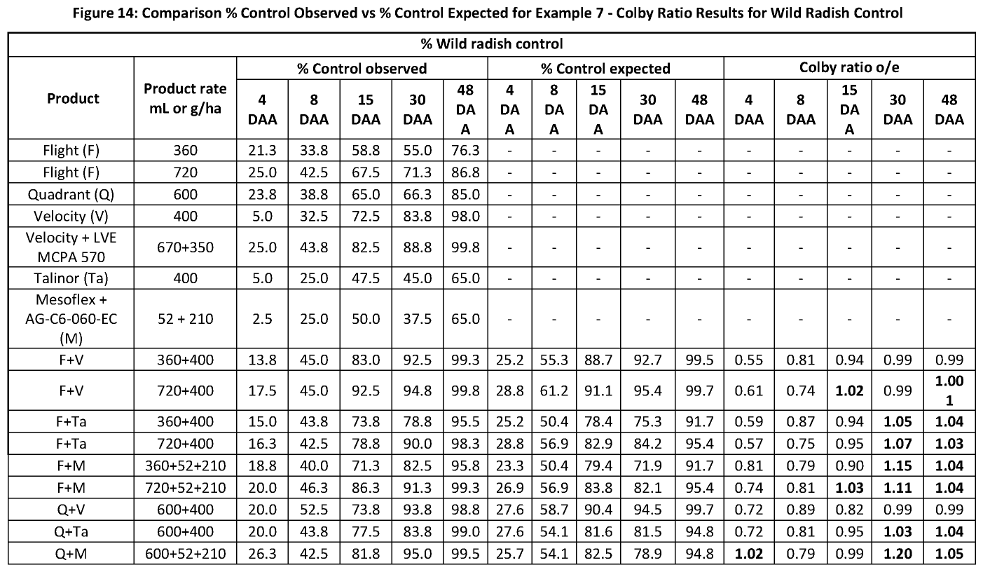

All tank mixtures evaluated were synergistic by the final assessment, except for Flight at 360 mL/ha or Quadrant at 600 mL/ha applied with Velocity at 400 mL/ha (FIG. 14).

### Example 8

This trial was conducted at Balakava in South Australia in 2019 and evaluated HPPD mixtures with Elevore and Pixxaro. The HPPD inhibitor products included were Velocity, Precept, Talinor, Mesoflex and Arietta. The main target weeds were bifora and fumitory, with the treatments applied listed in Table 15 below. The product names were as listed in Table 1 above.

TABLE 15
Treatments for Example 8

| | | Rate | |
|---|---|---|---|
| | | Product | Active Ingredient |
| No. | Product | (mL/ha) | (g AI/ha) |
| 1 | Untreated control | Nil | Nil |
| 2 | Velocity* | 670 | 172.1 |
| 3 | Pixxaro* | 200 | 53.25 |
| 4 | Elevore* | 48 | 3.28 |
| 5 | Precept* | 400 | 102.76 |
| 6 | Velocity + Elevore* | 400 + 48 | 102.76 + 3.28 |
| 7 | Precept* | 1500 | 234.4 |
| 8 | Precept + Elevore* | 1500 + 48 | 234.4 + 3.28 |
| 9 | Talinor* | 400 | 88.76 |
| 10 | Talinor + Elevore* | 400 + 48 | 88.76 + 3.28 |
| 11 | Talinor + Pixxaro* | 400 + 200 | 88.76 + 53.25 |
| 12 | Mesoflex + AG-C6-060 EC + | 52 + 210 + | 25 + 12.5 + |
| | LVE MCPA 570* | 220 | 125 |
| 13 | Mesoflex + AG-C6-060 EC + | 52 + 210 + | 25 + 12.5 + |
| | LVE MCPA 570 + Elevore* | 48 + 220 | 3.28 + 125 |
| 14 | Mesoflex + AG-C6-060 EC + | 52 + 210 + | 25 + 12.5 + |
| | LVE MCPA 570 + Pixxaro* | 200 + 220 | 53.25 + 125 |
| 15 | Arietta + AG-C6-060 EC + | 36 + 200 + | 12 + 12 + |
| | LVE MCPA 570* | 220 | 125 |
| 16 | Arietta + AG-C6-060 EC + | 36 + 200 + | 12 + 12 + |
| | LVE MCPA 570 + Elevore* | 48 + 220 | 3.28 + 125 |
| 17 | Arietta + AG-C6-060 EC + | 36 + 200 + | 12 + 12 + |
| | LVE MCPA 570 + Pixxaro* | 200 + 220 | 53.25 + 125 |

*= Treatment was applied with Uptake at 500 mL/100 L

Bifora Control

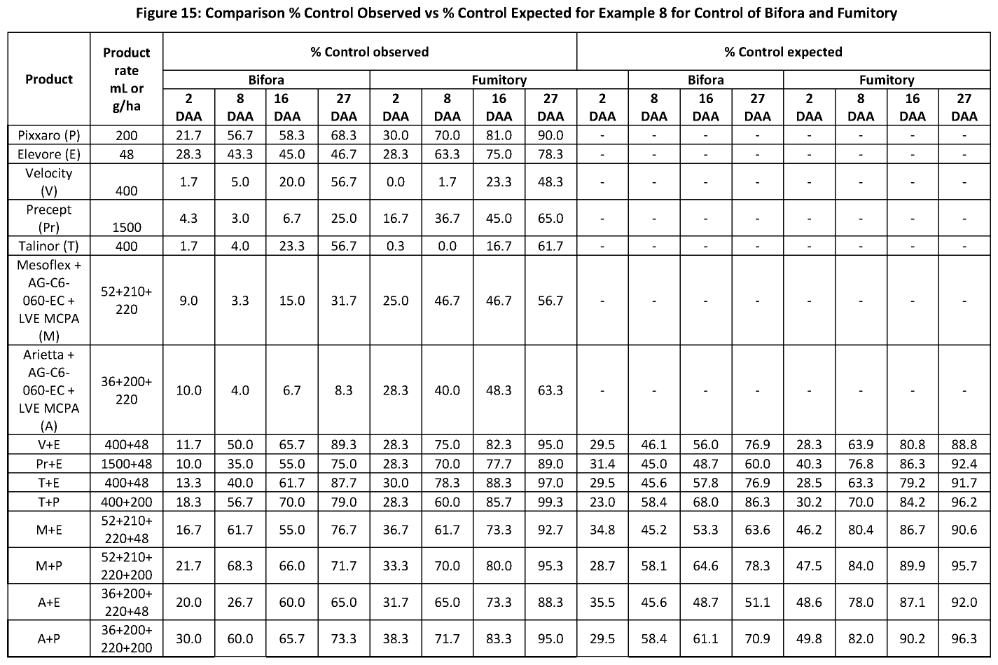

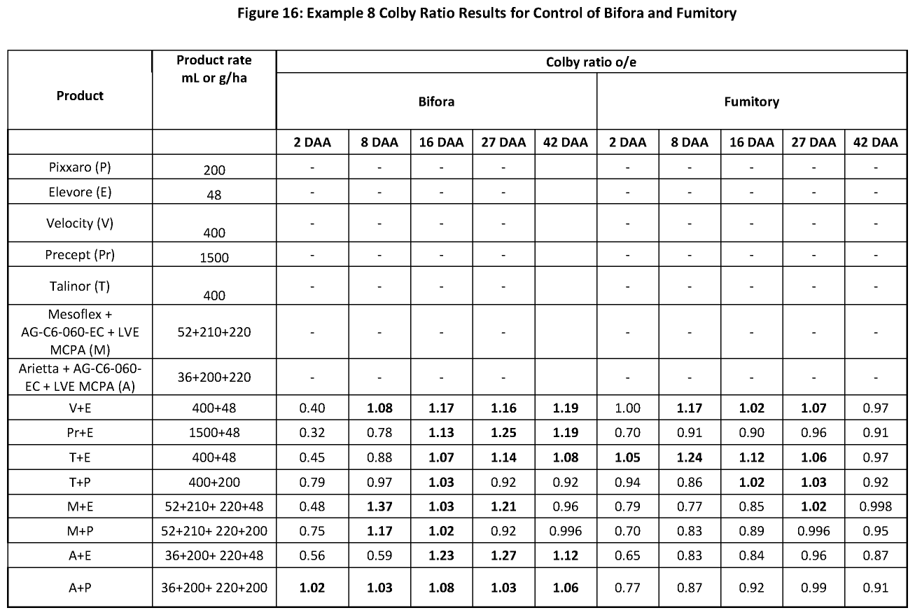

All HPPD mixtures were synergistic with Elevore and Pixxaro for bifora control by the third assessment timing, 16 days after application (FIGS. 15 and 16). Talinor, Mesoflex and Arietta+LVE MCPA 570 were synergistic on bifora when applied with Pixxaro, whether the effect was improving speed of activity or overall control.

Fumitory Control

Velocity was synergistic on fumitory when applied with Elevore (FIGS. 15 and 16). Talinor was synergistic on fumitory when applied with either Elevore or Pixxaro.

### Example 9

This trial was conducted at Watchman in South Australia in 2019 and evaluated HPPD mixtures with Elevore, Flagship 400 and Pixxaro on dense flowered fumitory, volunteer lupins and wild radish at the 3 leaf to 3 tiller stage. The HPPD inhibitor products included were Velocity, Precept, Talinor and Arietta, treatment list is in Table 16 below. All treatments were applied as a foliar application. The product names were as listed in Table 1 above.

Weed control assessments were conducted up to 47 days after application.

TABLE 16
Treatments for Example 9

| | | Product rate | | Active Ingredient |
|---|---|---|---|---|
| No. | Product | (mL or g/ha) | | (g AI/ha) |
| 1 | Untreated control | Nil | | Nil |
| 2 | Paradigm* | 25 | g | 10 |
| 3 | Velocity* | 400 | mL | 102.76 |
| 4 | Pixxaro* | 200 | mL | 56.5 |
| 5 | Flagship 400* | 250 | mL | 100 |
| 6 | Precept* | 1000 | mL | 156.25 |
| 7 | Elevore* | 48 | mL | 3.28 |
| 8 | Velocity + Flagship 400* | 400 mL + 250 mL | | 102.76 + 100 |
| 9 | Velocity + Elevore* | 400 mL + 48 mL | | 102.76 + 3.28 |
| 10 | Velocity + Pixxaro* | 400 mL + 200 mL | | 102.76 + 56.5 |
| 11 | Precept + Flagship 400* | 1000 mL + 250 mL | | 156.25 + 100 |
| 12 | Precept + Elevore* | 1000 mL + 48 mL | | 156.25 + 3.28 |
| 13 | Talinor* | 400 | mL | 88.76 |

| | | | |
|---|---|---|---|
| 14 | Talinor + Elevore* | 400 mL + 48 mL | 88.76 + 3.28 |
| 15 | Talinor + Pixxaro | 400 mL + 200 mL | 88.76 + 56.5 |
| 16 | Arietta + AG-C6-060 EC + | 36 mL + 200 mL + | 12 + 12 + 125 |
| | LVE MCPA 570* | 220 mL | |
| 17 | Arietta + AG-C6-060 EC + | 36 mL + 200 mL + | 12 + 12 + |
| | Flagship 400 + LVE MCPA 570* | 250 mL + 220 mL | 100 + 125 |
| 18 | Arietta + AG-C6-060 EC + | 36 mL + 200 mL + | 12 + 12 + |
| | Elevore + LVE MCPA 570* | 48 mL + 220 mL | 3.28 + 125 |
| 19 | Arietta + AG-C6-060 EC + | 36 mL + 200 mL + | 12 + 12 + |
| | Pixxaro + LVE MCPA 570* | 200 mL + 220 mL | 56.5 + 125 |

*Treatments applied with 0.5% v/v Uptake Spraying Oil

Fumitory Control

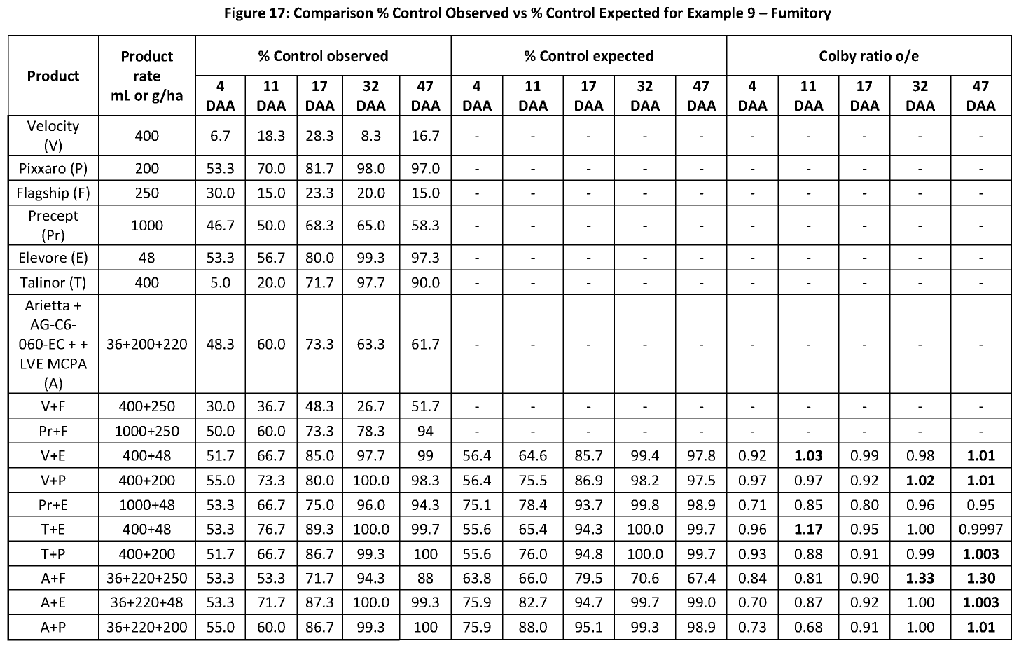

By the final assessment all combinations showed synergistic activity on fumitory at one or more assessment, except for Precept+Elevore (FIG. 17).

Lupin Control

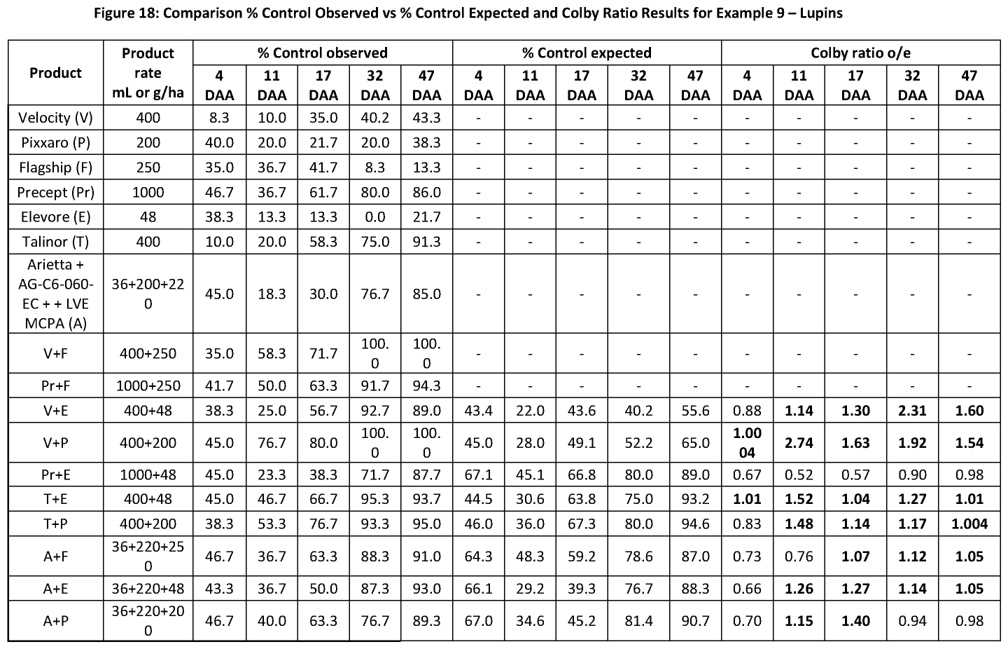

By the final assessment all combinations showed synergistic activity on lupins at one or more assessment, except for Precept+Elevore (FIG. 18). Velocity combinations with Elevore or Pixxaro were strongly synergistic, with standalone components providing less than 50% control at the final assessment and the combinations providing 89% and 100% control, respectively. Elevore was synergistic with Velocity, Talinor and Arietta+LVE MCPA 570. Pixxaro was synergistic with Velocity and Talinor, but not Arietta+LVE MCPA 570.

Wild Radish Control

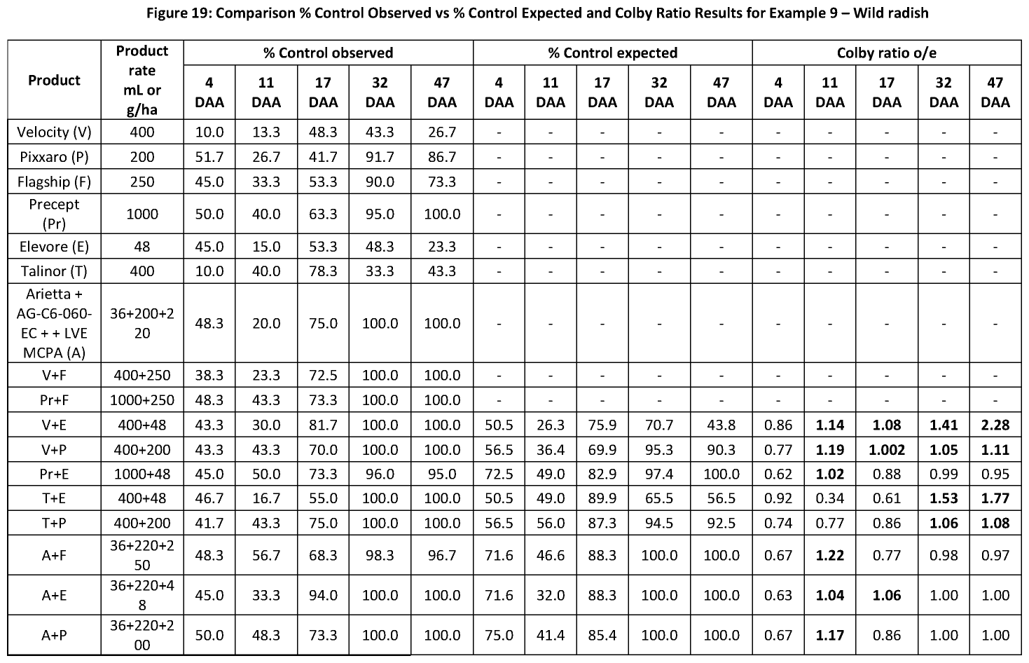

All combinations evaluated were synergistic at one or more assessments, providing improved early activity on wild radish or greater control at the final assessment (FIG. 19). The level of control provided by Arietta+LVE MCPA 570 was very high, with 100% control at 32 and 47 days after application. The addition of Flagship 400, Elevore or Pixxaro provided an increase in early weed control of Arietta+LVE MCPA 570 at the 11 days after application assessment.

### Example 10

This trial was conducted at Balaklava in South Australia in 2019, with the objective of evaluating mixtures of Fox with various herbicides when applied post emergent in wheat cv. Scepter for control of bifora and fumitory.

The product names were as listed in Table 1 above. Table 17 contains the treatment list for Example 10.

TABLE 17
Treatments for Example 10

| Trt | | | Rate | Product rate |
|---|---|---|---|---|
| No. | Treatment | Active ingredient | (g ai/ha) | (mL or g/ha) |
| 1 | Untreated | — | — | — |
| 2 | Affinity Force | Carfentrazone-ethyl 240 g/L | 24 | 100 |
| | MCPA 750 | MCPA amine 750 g/L | 247.5 | 330 |
| 3 | Paradigm | Florasulam 200 g/kg | 5 | 25 |
| | | Halauxifen-methyl 200 g/kg | 5 | |
| | LVE MCPA 570 | MCPA 570 g/L | 360 | 630 |
| | BS 1000 | Surfactant | | 200 mL/100 L |
| 4 | Velocity | Bromoxynil 210 g/L | 84 | 400 |
| | | Pyrasultotole 37.5 g/L | 15 | |
| | | Mefenpyr-diethyl 9.4 g/L | 3.76 | |
| | Uptake | Adjuvant | | 500 mL/100 L |
| 5 | Velocity | Bromoxynil 210 g/L | 140.7 | 670 |
| | | Pyrasultotole 37.5 g/L | 25.1 | |
| | | Mefenpyr-diethyl 9.4 g/L | 6.3 | |
| | Uptake | Adjuvant | | 500 mL/100 L |
| 6 | Elevore | Halauxifen-methyl 68.5 g/L | 5 | 73 |
| | BS 1000 | Surfactant | | 200 mL/100 L |
| 7 | Pixxaro | Fluroxypyr 250 g/L | 50 | 200 |
| | | Halauxifen 16.25 g/L | 3.25 | |
| | | Cloquintocet-mexyl 16.25 g/L | 3.25 | |
| | BS 1000 | Surfactant | | 200 mL/100 L |
| 8 | Precept | MCPA 125 g/L | 125 | 1000 |
| | | Pyrasultotole 25 g/L | 25 | |
| | | Mefenpyr-diethyl 6.25 g/L | 6.25 | |
| | Uptake | Adjuvant | | 500 mL/100 L |
| 9 | AD-AU-1826 | Florasulam 200 g/L | 5 | 25 |
| | BS 1000 | Surfactant | | 200 mL/100 L |
| 10 | Fox | Experimental 480 g/L | 480 | 1000 |
| 11 | Fox | Experimental 480 g/L | 720 | 1500 |
| 12 | Fox | Experimental 480 g/L | 1440 | 3000 |
| 13 | Fox | Experimental 480 g/L | 720 | 1500 |
| | MCPA 750 | MCPA amine 750 g/L | 247.5 | 330 |
| 14 | Fox | Experimental 480 g/L | 480 | 1000 |
| | Velocity | Bromoxynil 210 g/L | 84 | 400 |
| | | Pyrasultotole 37.5 g/L | 15 | |
| | | Mefenpyr-diethyl 9.4 g/L | 3.76 | |
| | Uptake | Adjuvant | | 500 mL/100 L |
| 15 | Fox | Experimental 480 g/L | 480 | 1000 |
| | Elevore | Halauxifen-methyl 68.5 g/L | 5 | 73 |
| | BS 1000 | Surfactant | | 200 mL/100 L |
| 16 | Fox | Experimental 480 g/L | 480 | 1000 |
| | Pixxaro | Fluroxypyr 250 g/L | 50 | 200 |
| | | Halauxifen 16.25 g/L | 3.25 | |
| | | Cloquintocet-mexyl 16.25 g/L | 3.25 | |
| | BS 1000 | Surfactant | | 200 mL/100 L |
| 17 | Fox | Experimental 480 g/L | 480 | 1000 |
| | Precept | MCPA 125 g/L | 125 | 1000 |
| | | Pyrasultotole 25 g/L | 25 | |
| | | Mefenpyr-diethyl 6.25 g/L | 6.25 | |
| | Uptake | Adjuvant | | 500 mL/100 L |
| 18 | Fox | Experimental 480 g/L | 480 | 1000 |
| | AD-AU-1826 | Florasulam 200 g/L | 5 | 25 |
| | BS 1000 | Surfactant | | 200 mL/100 L |

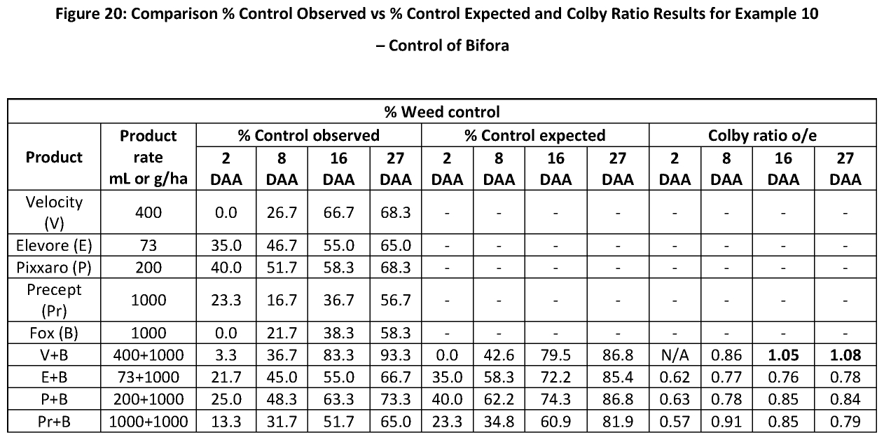

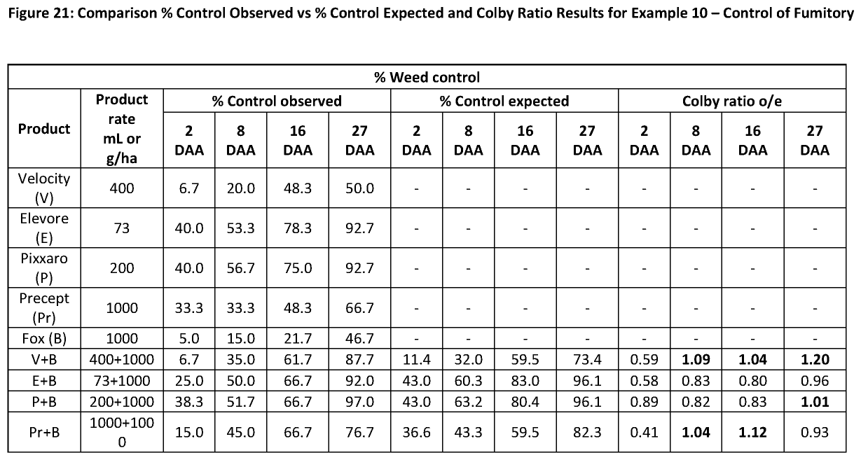

The results for bifora are set out in FIG. 20. The results shown in FIG. 21 indicated that Fox was synergistic when applied with Velocity, Pixxaro or Precept.

### Example 11

This trial was conducted at Walkaway in Western Australia in 2020, with the objective of evaluating mixtures of Racer with HPPD herbicides and bromoxynil and ioxynil mixtures in wheat cv. Scepter for control of wild radish. Herbicides were applied post emergent when the wild radish was at the 3 to 5 leaf stage.

The product names were as listed in Table 1 above. Table 18 contains the treatment list for Example 11.

TABLE 18
Treatments for Example 11

| Trt | | | Rate | Product rate |
|---|---|---|---|---|
| No. | Treatment | Active ingredient | (g ai/ha) | (mL or g/ha) |
| 1 | Untreated | — | — | — |
| 2 | Velocity | Bromoxynil 210 g/L | 140.7 | 670 |
| | | Pyrasultotole 37.5 g/L | 25.1 | |
| | | Mefenpyr-diethyl 9.4 g/L | 6.3 | |
| | LVE MCPA 570 | MCPA 570 g/L EC | 251 | 440 |
| | Hasten | Esterified vegetable oil | 900 | 1 L/100 L |
| | | 704 g/L + NIS 196 g/L | | |
| 3 | Racer 250 EC | Flurochloridone 250 g/L | 25 | 100 |
| 4 | Bronco 400 | Bromoxynil 400 g/L | 100 | 250 |
| 5 | Bronco 400 | Bromoxynil 400 g/L | 200 | 500 |
| 6 | Ioxynil 250 | Ioxynil 250 g/L | 100 | 400 |
| 7 | Ioxynil 250 | Ioxynil 250 g/L | 200 | 800 |
| 8 | Velocity | Bromoxynil 210 g/L | 105 | 500 |
| | Hasten | Pyrasultotole 37.5 g/L | 18.75 | |
| | | Mefenpyr-diethyl 9.4 g/L | 4.7 | |
| | | Esterified vegetable oil | 900 | 1 L/100 L |
| | | 704 g/L + NIS 196 g/L | | |
| 9 | Velocity | Bromoxynil 210 g/L | 105 | 500 |
| | | Pyrasultotole 37.5 g/L | 18.75 | |
| | | Mefenpyr-diethyl 9.4 g/L | 4.7 | |
| | Racer 250 EC | Flurochloridone 250 g/L | 25 | 100 |
| | Hasten | Esterified vegetable oil | 900 | 1 L/100 L |
| | | 704 g/L + NIS 196 g/L | | |
| 10 | Velocity | Bromoxynil 210 g/L | 105 | 500 |
| | | Pyrasultotole 37.5 g/L | 18.75 | |
| | | Mefenpyr-diethyl 9.4 g/L | 4.7 | |
| | Ioxynil 250 | Ioxynil 250 g/L | 100 | 400 |
| | Hasten | Esterified vegetable oil | 900 | 1 L/100 L |
| | | 704 g/L + NIS 196 g/L | | |
| 11 | Velocity | Bromoxynil 210 g/L | 105 | 500 |
| | | Pyrasultotole 37.5 g/L | 18.75 | |
| | | Mefenpyr-diethyl 9.4 g/L | 4.7 | |
| | Racer 250 EC | Flurochloridone 250 g/L | 25 | 100 |
| | Ioxynil 250 | Ioxynil 250 g/L | 100 | 400 |
| | Hasten | Esterified vegetable oil | 900 | 1 L/100 L |
| | | 704 g/L + NIS 196 g/L | | |
| 12 | Frequency | Topramezone 60 g/L | 12 | 200 |
| | | Cloquintocet-mexyl 60 g/L | 12 | |
| | Hasten | Esterified vegetable oil | 900 | 1 L/100 L |
| | | 704 g/L + NIS 196 g/L | | |
| 13 | Frequency | Topramezone 60 g/L | 12 | 200 |
| | | Cloquintocet-mexyl 60 g/L | 12 | |
| | Racer 250 EC | Flurochloridone 250 g/L | 25 | 100 |
| | Hasten | Esterified vegetable oil | 900 | 1 L/100 L |
| | | 704 g/L + NIS 196 g/L | | |
| 14 | Frequency | Topramezone 60 g/L | 12 | 200 |
| | | Cloquintocet-mexyl 60 g/L | 12 | |
| | Bronco 400 | Bromoxynil 400 g/L | 100 | 250 |
| | Hasten | Esterified vegetable oil | 900 | 1 L/100 L |
| | | 704 g/L + NIS 196 g/L | | |
| 15 | Frequency | Topramezone 60 g/L | 12 | 200 |
| | | Cloquintocet-mexyl 60 g/L | 12 | |
| | Bronco 400 | Bromoxynil 400 g/L | 200 | 500 |
| | Hasten | Esterified vegetable oil | 900 | 1 L/100 L |
| | | 704 g/L + NIS 196 g/L | | |
| 16 | Frequency | Topramezone 60 g/L | 12 | 200 |
| | | Cloquintocet-mexyl 60 g/L | 12 | |
| | Ioxynil 250 | Ioxynil 250 g/L | 100 | 400 |
| | Hasten | Esterified vegetable oil | 900 | 1 L/100 L |
| | | 704 g/L + NIS 196 g/L | | |
| 17 | Frequency | Topramezone 60 g/L | 12 | 200 |
| | | Cloquintocet-mexyl 60 g/L | 12 | |
| | Racer 250 EC | Flurochloridone 250 g/L | 25 | 100 |
| | Bronco 400 | Bromoxynil 400 g/L | 100 | 250 |
| | Hasten | Esterified vegetable oil | 900 | 1 L/100 L |
| | | 704 g/L + NIS 196 g/L | | |
| 18 | Frequency | Topramezone 60 g/L | 12 | 200 |
| | | Cloquintocet-mexyl 60 g/L | 12 | |
| | Racer 250 EC | Flurochloridone 250 g/L | 25 | 100 |
| | Ioxynil 250 | Ioxynil 250 g/L | 100 | 400 |
| | Hasten | Esterified vegetable oil | 900 | 1 L/100 L |
| | | 704 g/L + NIS 196 g/L | | |
| 19 | Frequency | Topramezone 60 g/L | 12 | 200 |
| | | Cloquintocet-mexyl 60 g/L | 12 | |
| | Bronco 400 | Bromoxynil 400 g/L | 100 | 250 |
| | Ioxynil 250 | Ioxynil 250 g/L | 100 | 400 |
| | Hasten | Esterified vegetable oil | 900 | 1 L/100 L |
| | | 704 g/L + NIS 196 g/L | | |
| 20 | Frequency | Topramezone 60 g/L | 12 | 200 |
| | | Cloquintocet-mexyl 60 g/L | 12 | |
| | Racer 250 EC | Flurochloridone 250 g/L | 25 | 100 |
| | Bronco 400 | Bromoxynil 400 g/L | 100 | 250 |
| | Ioxynil 250 | Ioxynil 250 g/L | 100 | 400 |
| | Hasten | Esterified vegetable oil | 900 | 1 L/100 L |
| | | 704 g/L + NIS 196 g/L | | |

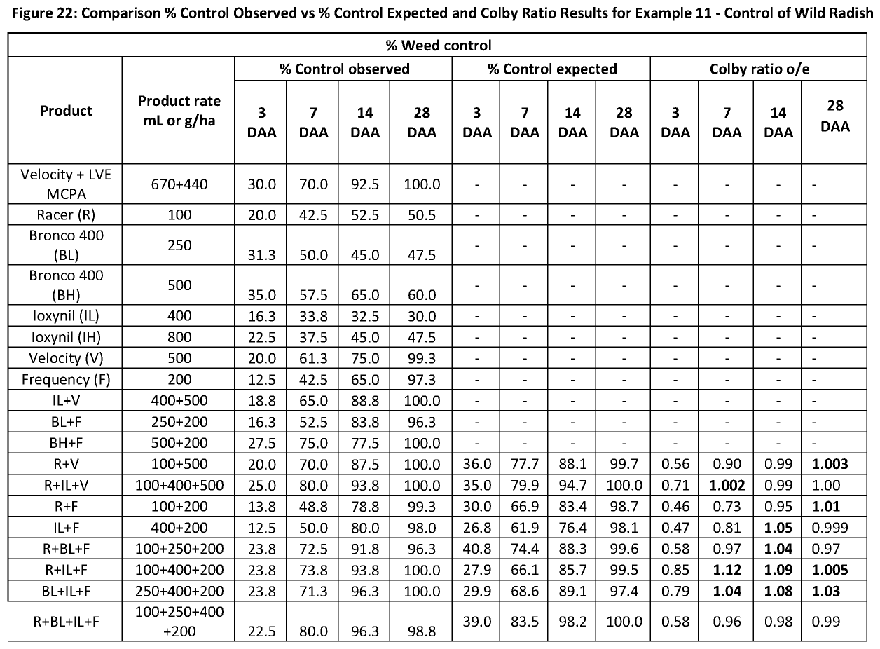

The percent control results are in FIG. 22. The results show that Racer provided synergistic control of wild radish when applied with Velocity alone or in combination with Ioxynil. Racer also provided synergistic control of wild radish when applied with Frequency alone or in combination with Ioxynil or Bronco 400. Frequency was also synergistic on wild radish when applied with both Ioxynil or Bronco 400.

### Example 12

This trial was conducted near Brookstead Queensland in 2019 to evaluate a range of herbicide mixtures on deadnettle in wheat. Herbicides were applied post emergent when the deadnettle were at the 6 to 12 leaf growth stage.

The product names were as listed in Table 1 above. Table 19 contains the treatment list for Example 12.

TABLE 19
Treatments for Example 12

| Trt | | | Rate | Product rate |
|---|---|---|---|---|
| No. | Treatment | Active ingredient | (g ai/ha) | (mL or g/ha) |
| 1 | Untreated | — | — | — |
| 2 | Velocity | Bromoxynil 210 g/L | 84 | 400 |
| | | Pyrasultotole 37.5 g/L | 15 | |
| | | Mefenpyr-diethyl 9.4 g/L | 3.76 | |
| | Uptake | Adjuvant | | 500 mL/100 L |
| 3 | Pixxaro | Fluroxypyr 250 g/L | 37.5 | 150 |
| | | Halauxifen 16.25 g/L | 2.44 | |
| | | Cloquintocet-mexyl 16.25 g/L | 2.44 | |
| | Uptake | Adjuvant | | 500 mL/100 L |
| 4 | Pixxaro | Fluroxypyr 250 g/L | 75 | 300 |
| | | Halauxifen 16.25 g/L | 4.88 | |
| | | Cloquintocet-mexyl 16.25 g/L | 4.88 | |
| | Uptake | Adjuvant | | 500 mL/100 L |
| 5 | Flagship 400 | Fluroxypyr 400 g/L | 100 | 250 |
| | Uptake | Adjuvant | | 500 mL/100 L |
| 6 | Precept | MCPA 125 g/L | 125 | 1000 |
| | | Pyrasultotole 25 g/L | 25 | |
| | | Mefenpyr-diethyl 6.25 g/L | 6.25 | |
| | Uptake | Adjuvant | | 500 mL/100 L |
| 7 | Elevore | Halauxifen-methyl 68.5 g/L | 2.47 | 36 |
| | Uptake | Adjuvant | | 500 mL/100 L |
| 8 | Velocity | Bromoxynil 210 g/L | 84 | 400 |
| | | Pyrasultotole 37.5 g/L | 15 | |
| | | Mefenpyr-diethyl 9.4 g/L | 3.76 | |
| | Elevore | Halauxifen-methyl 68.5 g/L | 2.47 | 36 |
| | Uptake | Adjuvant | | 500 mL/100 L |
| 9 | Precept | MCPA 125 g/L | 125 | 1000 |
| | | Pyrasultotole 25 g/L | 25 | |
| | | Mefenpyr-diethyl 6.25 g/L | 6.25 | |
| | Elevore | Halauxifen-methyl 68.5 g/L | 2.47 | 36 |
| | Uptake | Adjuvant | | 500 mL/100 L |
| 10 | Talinor | Bicyclopyrone 37.5 g/L | 15 | 400 |
| | | Bromoxynil 175 g/L | 70 | |
| | | Cloquintocet-mexyl 9.4 g/L | 3.76 | |
| | Uptake | Adjuvant | | 500 mL/100 L |
| 11 | Talinor | Bicyclopyrone 37.5 g/L | 15 | 400 |
| | | Bromoxynil 175 g/L | 70 | |
| | | Cloquintocet-mexyl 9.4 g/L | 3.76 | |
| | Elevore | Halauxifen-methyl 68.5 g/L | 2.47 | 36 |
| | Uptake | Adjuvant | | 500 mL/100 L |
| 12 | Talinor | Bicyclopyrone 37.5 g/L | 15 | 400 |
| | | Bromoxynil 175 g/L | 70 | |
| | | Cloquintocet-mexyl 9.4 g/L | 3.76 | |
| | Flagship 400 | Fluroxypyr 400 g/L | 100 | 250 |
| | Uptake | Adjuvant | | 500 mL/100 L |
| 13 | Talinor | Bicyclopyrone 37.5 g/L | 15 | 400 |
| | | Bromoxynil 175 g/L | 70 | |
| | | Cloquintocet-mexyl 9.4 g/L | 3.76 | |
| | Pixxaro | Fluroxypyr 250 g/L | 37.5 | 150 |
| | | Halauxifen 16.25 g/L | 2.44 | |
| | | Cloquintocet-mexyl 16.25 g/L | 2.44 | |
| | Uptake | Adjuvant | | 500 mL/100 L |
| 14 | Mesoflex | Experimental 480 g/L | 25 | 52 |
| | AG-C6-060 EC | Cloquintocet-mexyl 60 g/L | 12.5 | 210 |
| | LVE MCPA 570 | MCPA ester 570 g/L | 125 | 220 |
| | Uptake | Adjuvant | | 500 mL/100 L |
| 15 | Mesoflex | Experimental 480 g/L | 25 | 52 |
| | AG-C6-060 EC | Cloquintocet-mexyl 60 g/L | 12.5 | 210 |
| | LVE MCPA 570 | MCPA ester 570 g/L | 125 | 220 |
| | Elevore | Halauxifen-methyl 68.5 g/L | 2.47 | 36 |
| | Uptake | Adjuvant | | 500 mL/100 L |
| 16 | Mesoflex | Experimental 480 g/L | 25 | 52 |
| | AG-C6-060 EC | Cloquintocet-mexyl 60 g/L | 12.5 | 210 |
| | LVE MCPA 570 | MCPA ester 570 g/L | 125 | 220 |
| | Pixxaro | Fluroxypyr 250 g/L | 37.5 | 150 |
| | | Halauxifen 16.25 g/L | 2.44 | |
| | | Cloquintocet-mexyl 16.25 g/L | 2.44 | |
| | Uptake | Adjuvant | | 500 mL/100 L |
| 17 | Arietta | Topramezone 336 g/L | 12 | 36 |
| | AG-C6-060 EC | Cloquintocet-mexyl 60 g/L | 12 | 200 |
| | LVE MCPA 570 | MCPA ester 570 g/L | 125 | 220 |
| | Uptake | Adjuvant | | 500 mL/100 L |
| 18 | Arietta | Topramezone 336 g/L | 12 | 36 |
| | AG-C6-060 EC | Cloquintocet-mexyl 60 g/L | 12 | 200 |
| | LVE MCPA 570 | MCPA ester 570 g/L | 125 | 220 |
| | Elevore | Halauxifen-methyl 68.5 g/L | 2.47 | 36 |
| | Uptake | Adjuvant | | 500 mL/100 L |
| | Arietta | Topramezone 336 g/L | 12 | 36 |
| | AG-C6-060 EC | Cloquintocet-mexyl 60 g/L | 12 | 200 |
| 19 | LVE MCPA 570 | MCPA ester 570 g/L | 125 | 220 |
| | Flagship 400 | Fluroxypyr 400 g/L | 100 | 250 |
| | Uptake | Adjuvant | | 500 mL/100 L |
| 20 | Arietta | Topramezone 336 g/L | 12 | 36 |
| | AG-C6-060 EC | Cloquintocet-mexyl 60 g/L | 12 | 200 |
| | LVE MCPA 570 | MCPA ester 570 g/L | 125 | 220 |
| | Pixxaro | Fluroxypyr 250 g/L | 37.5 | 150 |
| | | Halauxifen 16.25 g/L | 2.44 | |
| | | Cloquintocet-mexyl 16.25 g/L | 2.44 | |
| | Uptake | Adjuvant | | 500 mL/100 L |

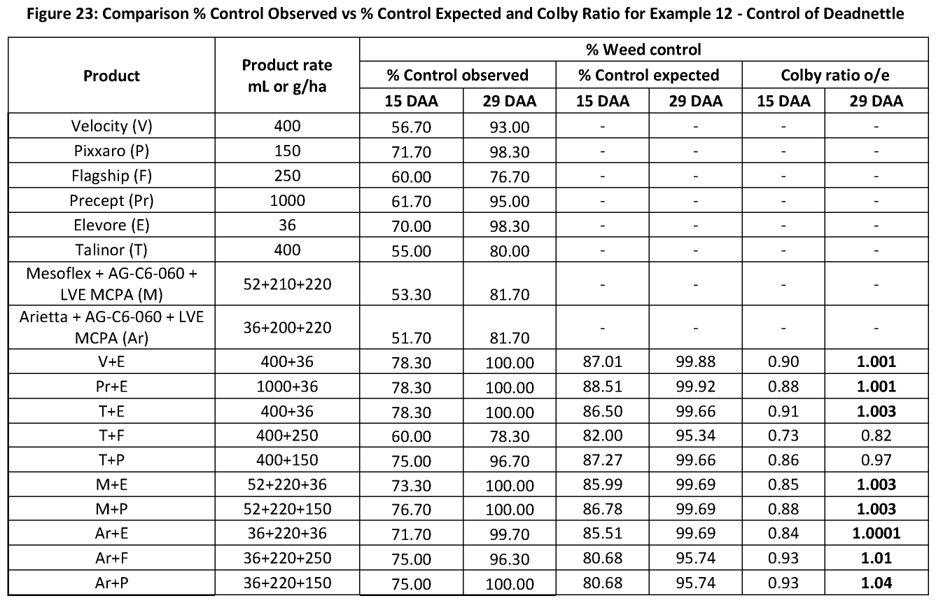

The percent control results are in FIG. 23. The results show that Elevore provided synergistic control of deadnettle when applied with Velocity, Precept, Talinor, Mesoflex+LVE MCPA 570+AG-C6-060 EC or Arietta+LVE MCPA 570+AG-C6-060 EC. In addition, Pixxaro provided synergistic control of deadnettle when applied with Mesoflex+LVE MCPA 570+AG-C6-060 EC or Arietta+LVE MCPA 570+AG-C6-060 EC. Arietta+LVE MCPA 570+AG-C6-060 EC was also synergistic with Flagship 400.

### INDUSTRIAL APPLICABILITY

The new synergistic HPPD combinations disclosed herein may improve weed species control in cereal crops at an early stage after application, reducing weed competition and enhancing grain yield.

The new synergistic HPPD combinations may also control hard-to-kill weeds and herbicide resistant weeds, often being highly effective at reduced application rates compared to prior art rates.

1. A herbicidal composition, comprising an effective amount of:
A) one or more HPPD inhibitors, selected from a group comprising: an isoxazole, a triketone, and a callistemone;
B) a safener suitable for the cereal crop, wherein the safener is selected from a group comprising mefenpyr-diethyl, cloquintocet and cloquintocet-mexyl; and
C) one or more of the herbicides, selected from the groups comprising:
i) a PSII inhibitor, including bromoxynil, ioxynil, and chlorotoluron
ii) a synthetic auxin, including halauxifen-methyl, fluroxypyr and MCPA
iii) a PPO inhibitor, including bifenox
iv) a PDS inhibitor, including flurochloridone, diflufenican and picolinafen.

2. The herbicidal composition as claimed in claim 1, comprising an effective amount of one or more HPPD inhibitors selected from a group comprising Pyrasulfotole, Bicyclopyrone, Topramezone and Mesotrione.

3. The herbicidal composition as claimed in claim 2, comprising an effective amount of:
A) Pyrasulfotole;
B) a safener suitable for the cereal crop, wherein the safener is selected from a group comprising mefenpyr-diethyl, cloquintocet and cloquintocet-mexyl; and
C) one or more of the herbicides, selected from the groups comprising:
a PSII inhibitor, which includes bromoxynil, ioxynil, and chlorotoluron;
a synthetic auxin, which includes halauxifen-methyl, fluroxypyr and MCPA;
a PPO inhibitor, which includes bifenox; and
a PDS inhibitor, which includes flurochloridone, diflufenican and picolinafen.

4. The herbicidal composition as claimed in claim 2, comprising an effective amount of:
A) Bicyclopyrone;
B) a safener suitable for the cereal crop, wherein the safener is selected from a group comprising mefenpyr-diethyl, cloquintocet and cloquintocet-mexyl; and
C) one or more of the herbicides, selected from the groups comprising:
a PSII inhibitor, which includes bromoxynil, ioxynil, and chlorotoluron;
a synthetic auxin, which includes halauxifen-methyl, fluroxypyr and MCPA;
a PPO inhibitor, which includes bifenox; and
a PDS inhibitor, which includes flurochloridone, diflufenican and picolinafen.

5. The herbicidal composition as claimed in claim 2, comprising an effective amount of:
A) Topramezone;
B) a safener suitable for the cereal crop, wherein the safener is selected from a group comprising mefenpyr-diethyl, cloquintocet and cloquintocet-mexyl; and
C) one or more of the herbicides, selected from the groups comprising:
a PSII inhibitor, which includes bromoxynil, ioxynil, and chlorotoluron;
a synthetic auxin, which includes halauxifen-methyl, fluroxypyr and MCPA;
a PPO inhibitor, which includes bifenox; and
a PDS inhibitor, which includes flurochloridone, diflufenican and picolinafen.

6. The herbicidal composition as claimed in claim 2, comprising an effective amount of:
A) Mesotrione;
B) a safener suitable for the cereal crop, wherein the safener is selected from a group comprising mefenpyr-diethyl, cloquintocet and cloquintocet-mexyl; and
C) one or more of the herbicides, selected from the groups comprising:
a PSII inhibitor, which includes bromoxynil, ioxynil, and chlorotoluron;
a synthetic auxin, which includes halauxifen-methyl, fluroxypyr and MCPA;
a PPO inhibitor, which includes bifenox; and
a PDS inhibitor, which includes flurochloridone, diflufenican and picolinafen.

7. The herbicidal composition as claimed in claim 1, which comprises the components (A), (B) and (C) in a weight ratio of x:y:z, wherein x, y and z are independently 1 to 200.

8. The herbicidal composition as claimed in claim 1, additionally comprising formulating agents customary in crop protection

9. The herbicidal composition as claimed in claim 1, additionally comprising adjuvants.

10. The herbicidal composition as claimed in claim 9, wherein the adjuvants comprising esterified vegetable oil, non-ionic surfactants, paraffinic oil and the mixtures thereof.

11. The herbicidal composition as claimed in claim 10, wherein the non-ionic surfactants adjuvants comprising 1000 g/L alcohol alkoxylates, including BS 1000.

12. A method for controlling unwanted vegetation applying the composition as claimed in claim 1, which comprises applying the components (A), (B) and (C) jointly or separately to the plants, to parts of plants, to plant seeds or to the area on which the plants grow.

13. The method as claimed in claim 12 wherein said unwanted vegetation comprises harmful plants in crops of useful plants.

14. The method as claimed in claim 13 wherein said unwanted vegetation comprises harmful plants in cereal crops.

15. The method as claimed in claim 14 wherein the herbicidal composition is applied to a cereal crop post-emergent.

16. The method as claimed in claim 14 wherein said unwanted vegetation comprises harmful plants in wheat, barley, cereal rye and triticale.

17. The method as claimed in claim 12, wherein the herbicidal composition is applied in an amount of 1 to 1000 g/ha.

18. The method of claim 12 wherein the unwanted vegetation is selected from a group comprising Fumitory (Fumaria spp), Vetch (Vicia sativa), Wild radish (Raphanus raphanistrum), Bifora (Bifora testiculata), Volunteer lupins (Lupinus spp) and Climbing buckwheat (Polygonum convolvulus) weed species.

19. The method as claimed in claim 18 wherein the unwanted vegetation group includes biotypes resistant to one or more herbicide modes of action.
